(19) United States
(12) Patent Application Publication
(10) Pub. No.: US 2022/0405772 A1
(43) Pub. Date: Dec. 22, 2022

(54) INFORMATION PROCESSING SYSTEM AND INFORMATION PROCESSING METHOD

(71) Applicant: FRONTEO, Inc., Tokyo (JP)

(72) Inventors: Toru HISAMITSU, Tokyo (JP); Kazumi HASUKO, Tokyo (JP); Kosei INATSU, Tokyo (JP)

(21) Appl. No.: 17/843,452

(22) Filed: Jun. 17, 2022

(30) Foreign Application Priority Data
Jun. 21, 2021 (JP) 2021-102783

(51) Int. Cl. G06Q 30/00; G06Q 30/02

(52) U.S. Cl. CPC G06Q 30/018; G06Q 30/0201

(57) ABSTRACT

An information processing system includes: a supply chain network acquisition section configured to acquire a supply chain network, in which a plurality of nodes corresponding to a plurality of companies are linked based on open information; an input receiving section configured to receive a selection operation of selecting any of the plurality of companies as a company of interest; a sub-network extraction section configured to perform a process of extracting, from the supply chain network, a sub-network including either one or both of an upstream sub-network and a downstream sub-network; a company-of-special-interest identifying section configured to identify a company of special interest that meets a given condition in the sub-network; and a presentation processing section configured to perform a process of presenting information on the company of special interest.

### CROSS-REFERENCE TO RELATED APPLICATION

The present application claims priority from Japanese Application JP2021-102783, the content of which is hereby incorporated by reference into this application.

### BACKGROUND OF THE INVENTION

### 1. Field of the Invention

The present invention relates to information processing systems and information processing methods.

### 2. Description of the Related Art

Various supply chain analysis and related techniques have been known. A supply chain refers to a series of activities from the procurement of raw materials and components of a product to the manufacture, inventory management, delivery, sale, and consumption of the product. “Supply Chain Management by Manufacturing Companies in Japan,” by MATSUI Yoshiki, Yokohama Business Review, Vol. 29, No. 3 (September 2008), pages 205-220, as an example, discloses supply chain management (SCM) techniques.

### SUMMARY OF THE INVENTION

In the analysis of a given company's SCM by a conventional technique, for example, the companies involved in a supply chain of that company are determined in advance to perform, for example, demand prediction, production planning, procurement planning, sales planning, order management, transport and delivery management, or client management by using the supply chain. Conventional analysis techniques need to focus on the supply chain of a specific target company and hardly applicable to general-purpose analysis.

The present disclosure, in some aspects thereof, provides, for example, an information processing system and an information processing method both for suitable analysis of a supply chain of a given company.

The present disclosure, in an aspect thereof, is related to an information processing system including: a supply chain network acquisition section configured to acquire a supply chain network, in which a plurality of nodes are linked, based on open information including business relationship information, the plurality of nodes corresponding to a plurality of companies, the business relationship information being information associating a supply source company with a supply destination company for a product; an input receiving section configured to receive a selection operation of selecting any of the plurality of companies as a company of interest; a sub-network extraction section configured to perform a process of extracting, from the supply chain network, a sub-network including either one or both of an upstream sub-network and a downstream sub-network, the upstream sub-network including an upstream company that supplies a product to the company of interest, the downstream sub-network including a downstream company that receives a product from the company of interest; a company-of-special-interest identifying section configured to identify a company of special interest that meets a given condition in the sub-network; and a presentation processing section configured to perform a process of presenting information about the company of special interest.

The present disclosure, in another aspect thereof, is related to an information processing method including: acquiring a supply chain network, in which a plurality of nodes are linked, based on open information including business relationship information, the plurality of nodes corresponding to a plurality of companies, the business relationship information being information associating a supply source company with a supply destination company for a product; receiving a selection operation of selecting any of the plurality of companies as a company of interest; performing a process of extracting, from the supply chain network, a sub-network including either one or both of an upstream sub-network and a downstream sub-network, the upstream sub-network including an upstream company that supplies a product to the company of interest, the downstream sub-network including a downstream company that receives a product from the company of interest; identifying a company of special interest that meets a given condition in the sub-network; and performing a process of presenting information about the company of special interest.

### BRIEF DESCRIPTION OF THE DRAWINGS

FIG. 1 shows an exemplary structure of an information processing system.

FIG. 2 shows an exemplary structure of a server system.

FIG. 3 shows an exemplary structure of a terminal device.

FIG. 4 is a flow chart representing a process performed by the information processing system.

FIG. 5A shows an example of information obtained on the basis of open information.

FIG. 5B shows another example of information obtained on the basis of open information.

FIG. 5C shows a part of an exemplary supply chain network acquired on the basis of open information.

FIG. 6 is a diagram of a supply chain network.

FIG. 7 is a flow chart of an upstream sub-network extraction process.

FIG. 8A shows a part of an exemplary sub-network.

FIG. 8B shows a part of another exemplary sub-network.

FIG. 9 shows an exemplary sub-network.

FIG. 10 is a flow chart of a downstream sub-network extraction process.

FIG. 11A is a flow chart of a process of identifying a company of special interest.

FIG. 11B is a flow chart of a process of identifying a company of special interest.

FIG. 12 is a flow chart of a presentation process.

FIG. 13 shows an exemplary image displayed in the presentation process.

FIG. 14 shows an exemplary image displayed in the presentation process.

FIG. 15 shows an exemplary complex sub-network.

FIG. 16 is a flow chart of an upstream sub-network extraction process.

FIG. 17 is a flow chart of a process of identifying a company of special interest.

FIG. 18 is a flow chart of a presentation process.

FIG. 19A shows an exemplary image displayed in the presentation process.

FIG. 19B shows an exemplary image displayed in the presentation process.

FIG. 20 is a flow chart of an upstream sub-network extraction process.

### DETAILED DESCRIPTION OF THE INVENTION

The following will describe the present embodiment with reference to drawings. Identical and equivalent elements in the drawings are denoted by the same reference numerals, and description thereof is not repeated. The scope of the disclosure should not be unreasonably limited by the present embodiment described below. Not all the members and elements described in the present embodiment are essential to the present disclosure.

### 1. Example of System Structure

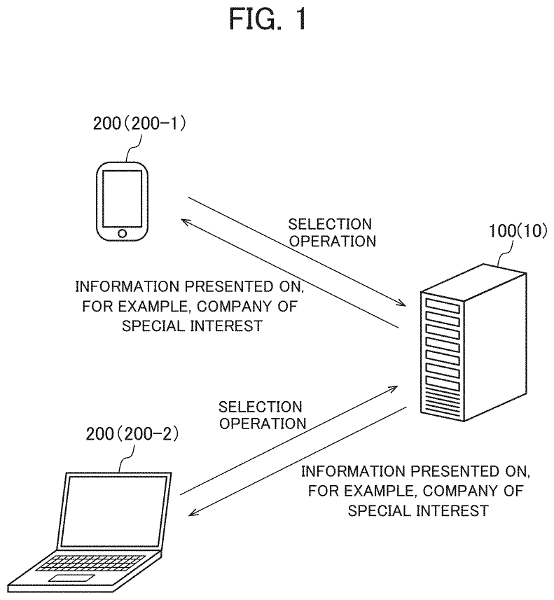

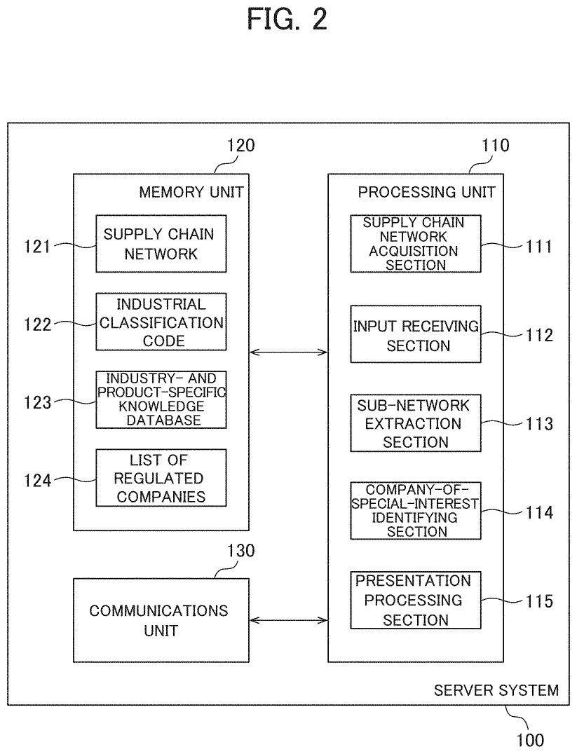

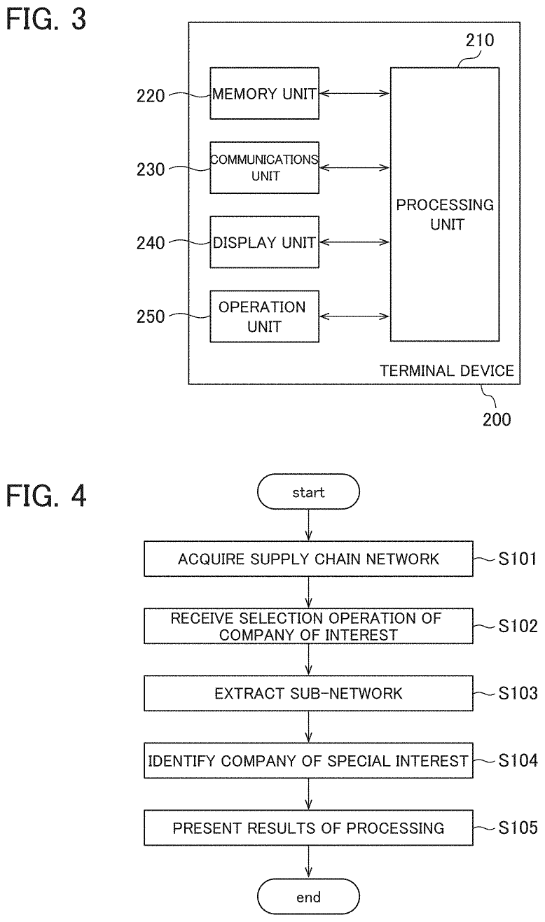

FIG. 1 shows an exemplary structure of a system including an information processing system 10 in accordance with the present embodiment. The system in accordance with the present embodiment includes a server system 100 and terminal devices 200. The structure of the system including the information processing system 10 is not necessarily limited to the one shown in FIG. 1 and may be modified in various manners, for example, by omitting some parts of the structure or by including additional structural elements. For instance, FIG. 1 shows two terminal devices 200-1 and 200-2 as an example of the terminal devices 200. Alternatively, there may be provided only one terminal device 200 or three or more terminal devices 200. The same description applies to FIG. 2 and FIG. 3 (detailed below), regarding variations including the omission of some of the structural elements and the inclusion of additional structural elements.

The information processing system 10 in accordance with the present embodiment is an equivalent of, for example, the server system 100. The technique in accordance with the present embodiment is however not necessarily limited to this example. The functions of the information processing system 10 may be provided by distributed processing performed by the server system 100 in concert with other apparatus. For instance, the information processing system 10 in accordance with the present embodiment may be provided by distributed processing between the server system 100 and the terminal device 200. The following will focus on examples where the information processing system 10 is the server system 100.

The server system 100 may include a single server or a plurality of servers. For instance, the server system 100 may include a database server and an application server. The database server stores a supply chain network 121 (which will be described later) and other various data. The application server performs processes that will be described later with reference to, for example, FIG. 4. The plurality of servers may be physical servers or virtual servers. A virtual server may be provided by a single physical server or by a plurality of physical servers in a distributed manner. The specific structure of the server system 100 can have many variations in the present embodiment as described here.

The terminal device 200 is used by a user of the information processing system 10. The terminal device 200 may be a PC (personal computer), a mobile terminal such as a smartphone, or any other like apparatus.

The server system 100 is connected to the terminal device 200-1 and the terminal device 200-2, for example, over a network. The terminal device 200-1 and the terminal device 200-2 will be simply referred to as the terminal device 200 throughout the following description when there is no need to distinguish between multiple terminal devices. The network in this context is, for example, a public communications network such as the Internet and may be, for example, a LAN (local area network).

The information processing system 10 in accordance with the present embodiment is an OSINT (open source intelligence) system, for example, for collecting and analyzing data related to a target entity by using, for example, open information. The open information in this context includes various information that is legally available and widely accessible, such as securities reports, inter-industry relations tables, governments' official announcements, news reports on countries and companies, and supply chain databases. The open information may include various information transmitted and received via SNS (social networking service). For instance, this SNS may include services where users can post, for example, text and images. The open information in the present embodiment may include such text and images and results of, for example, natural language processing and image processing of the text and images.

The server system 100 generates nodes with various attributes on the basis of open information. Each node represents a given entity, which in this context is a company. Attributes of a node are various information determined on the basis of open information and include the company's name, nationality, business fields, business partners, and traded goods. The attributes in this context may include, for example, sales, the number of employees, shareholders and their capital contribution ratios, and board members.

If a given node has an attribute associated with another node, the two nodes are linked together by a directional edge. As an example, if a given company provides (sells) traded products to another company, the node representing the given company is linked to the node representing the other company by an edge representing a product buying/selling relationship (distribution relationship). An edge in this context has directionality from an entity that gives influence to an entity that receives the influence, for example, from an entity that sells a product to an entity that buys the product.

According to the technique in accordance with the present embodiment, the server system 100 acquires an entity network composed of a plurality of nodes, each representing an entity, that are linked together by attribute-based directional edges. In other words, the entity network is a directed graph. The server system 100 performs analysis based on the entity network and implements a process of presenting results of the analysis. For instance, the terminal device 200 is used by a user of a service provided by an OSINT system. For instance, the user makes on the terminal device 200 a request that the server system 100 (information processing system 10) perform some analysis. The server system 100 performs analysis based on the entity network and feeds the results of the analysis to the terminal device 200. The entity network in the present embodiment is, in a narrow sense of the term, the supply chain network 121 representing a supply chain.

FIG. 2 is a detailed block diagram of an exemplary structure of the server system 100. The server system 100 includes, for example, a processing unit 110, a memory unit 120, and a communications unit 130.

The processing unit 110 in accordance with the present embodiment includes hardware that may include either one or both of a digital signal processing circuit and an analog signal processing circuit. For instance, the hardware may include one or more circuit elements or devices mounted to a circuit board. The circuit device is, for example, an IC (integrated circuit) chip or an FPGA (field-programmable gate array). The circuit element is, for example, a resistor or a capacitor.

The processing unit 110 may be provided by the processor described below. The server system 100 in accordance with the present embodiment includes an information-containing memory and a processor that operates on the basis of the information stored in the memory. The information is, for example, programs and various data. The processor includes hardware. The processor may be any processor including a CPU (central processing unit), a GPU (graphics processing unit), and a DSP (digital signal processor). The memory may be, for example, a semiconductor memory such as an SRAM (static random access memory), a DRAM (dynamic random access memory), or a flash memory; a register; a magnetic storage device such as a hard disk drive (HDD); or an optical storage device such as an optical disc drive. For instance, the memory contains computer-readable instructions, so that the processor can execute the instructions to provide the functions of the processing unit 110. These instructions may be a set of instructions included in a program or instructions for instructing the processor hardware circuitry to operate.

The processing unit 110 includes, for example, a supply chain network acquisition section 111, an input receiving section 112, a sub-network extraction section 113, a company-of-special-interest identifying section 114, and a presentation processing section 115.

The supply chain network acquisition section 111 acquires the supply chain network 121. For instance, the supply chain network acquisition section 111 may prepare the supply chain network 121 on the basis of open information. The open information includes business relationship information that associates a product supply source company with a product supply destination company. The supply chain network acquisition section 111 stores the generated supply chain network 121 in the memory unit 120. Alternatively, the supply chain network 121 may be generated by a system other than the information processing system 10 in accordance with the present embodiment, in which case the supply chain network acquisition section 111 may perform a process of acquiring a result of such generation from the other system.

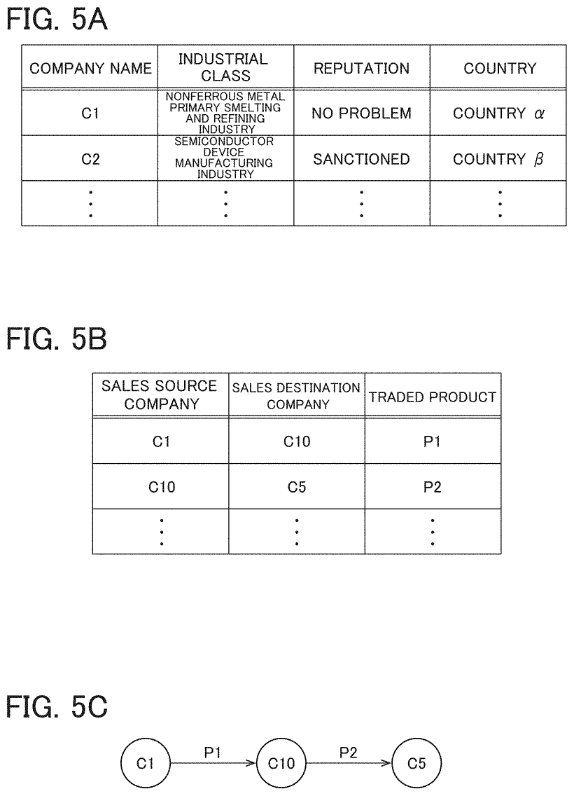

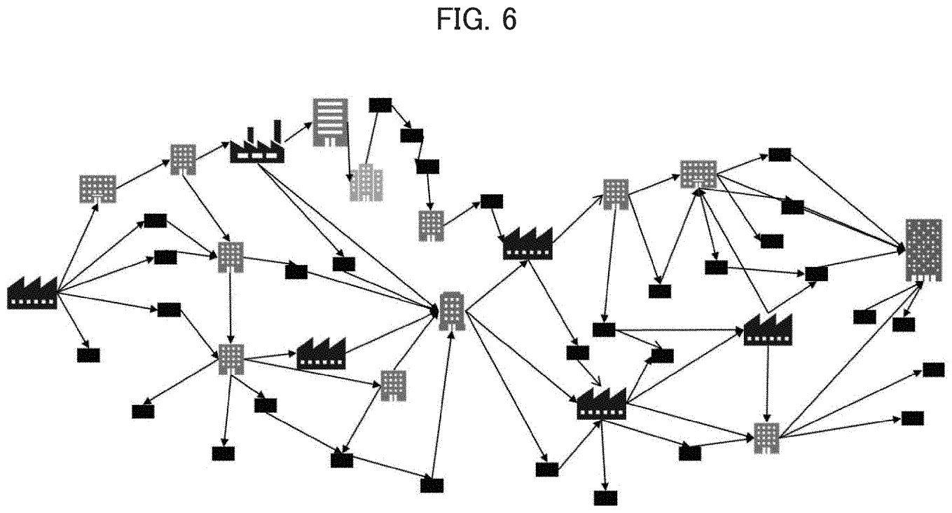

The supply chain network acquisition section 111 may acquire, as the supply chain network 121, a network of interlinked nodes representing respective companies on the basis of business relationships between entities (companies) as will be described later with reference to, for example, FIGS. 5A to 5C.

The input receiving section 112 performs a process of receiving input operations from the user of the information processing system 10. These input operations include an operation of receiving a selection of a company of interest. A company of interest serves as a reference in the analysis performed by the information processing system 10.

The sub-network extraction section 113 performs a process of extracting a part of the supply chain network 121 acquired by the supply chain network acquisition section 111 as a sub-network. A sub-network is a directed graph of, for example, a part of the supply chain network 121 that includes a group of nodes linked directly or indirectly to a node representing a company of interest.

The company-of-special-interest identifying section 114 performs a process of identifying a company of special interest that meets given conditions among the companies in the sub-network extracted by the sub-network extraction section 113. A company of special interest in this context is, for example, a regulated company whose commercial activities are regulated, and more specifically may be an entity that is controversial in view of ESG (environment, social, governance) standards or may be an entity represented by a choke point in the sub-network.

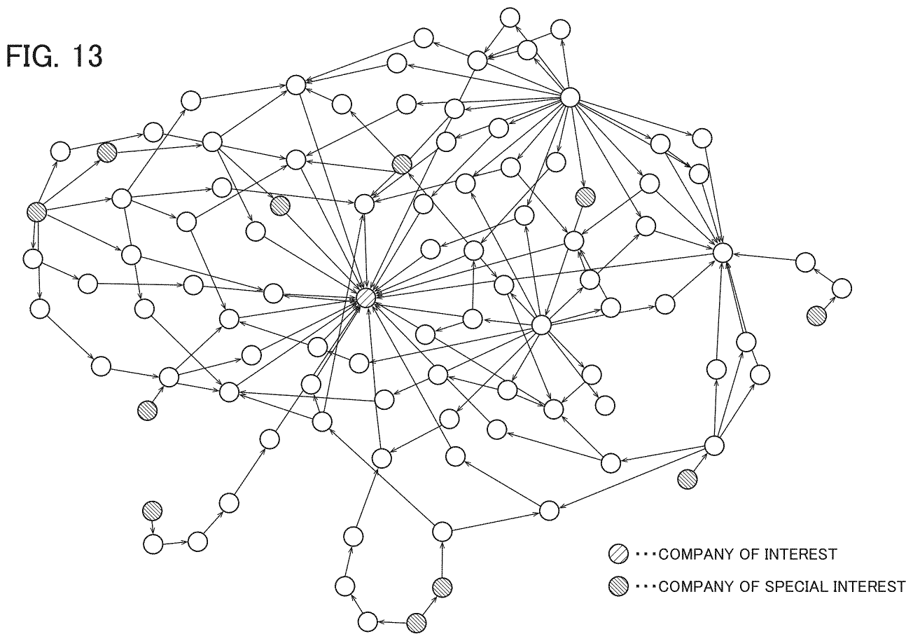

The presentation processing section 115 performs a process of presenting a result of identifying a company of special interest to the user. The presentation processing section 115 performs a process of displaying a display screen detailed later with reference to, for example, FIGS. 13, 14, 19A, and 19B. The display screen is displayed, for example, on a display unit 240 in the terminal device 200. For instance, the presentation processing section 115 performs a process of generating a display screen and transmitting the display screen to the terminal device 200 via the communications unit 130. The presentation processing section 115 does not necessarily transmit the display screen per se, and may transmit information from which the display screen can be generated (e.g., in a markup language). Alternatively, the display screen may be displayed on a device other than the terminal device 200, for example, on the server system 100. The presentation processing section 115 does not necessarily perform the display process in the presentation process and may make, for example, an audio output.

The memory unit 120 is a working area for the processing unit 110 and stores various information. The memory unit 120 may be any memory device including a semiconductor memory such as an SRAM, a DRAM, a ROM, or a flash memory; a register; a magnetic storage device such as a hard disk drive; or an optical storage device such as an optical disc drive.

The memory unit 120 stores, for example, the supply chain network 121 acquired by the supply chain network acquisition section 111. The memory unit 120 may contain open information such as a securities report or an inter-industry relations table. The memory unit 120 may additionally contain, for example, industrial classification codes 122, an industry- and product-specific knowledge database 123, and/or a list of regulated companies 124. The industrial classification codes 122 are codes, for example, “01,” assigned to one of classes into which various industries are divided. The industry- and product-specific knowledge database 123 is a collection of information on a given industry or the supply chain of a given product. The list of regulated companies 124 is information for identifying a company that is controversial in view of, for example, ESG standards. The memory unit 120 may contain various other information related to the processes performed in accordance with the present embodiment.

The communications unit 130 provides an interface for performing communications over a network and includes, for example, an antenna, an RF (radio frequency) circuit, and a baseband circuit. The communications unit 130 may operate under the control of the processing unit 110 and may include a communications controlling processor other than the processing unit 110. The communications unit 130 provides an interface for performing communications in accordance with, for example, the TCP/IP (transmission control protocol/Internet protocol). The specific communications scheme however can have many variations.

FIG. 3 is a detailed block diagram of an exemplary structure of the terminal device 200. The terminal device 200 includes a processing unit 210, a memory unit 220, a communications unit 230, the display unit 240, and an operation unit 250.

The processing unit 210 is provided by hardware including either one or both of a digital signal processing circuit and an analog signal processing circuit. The processing unit 210 may be provided by a processor. This processor may be any processor including a CPU, a GPU, and a DSP. The processor executes the instructions stored in the memory of the terminal device 200 to provide the functions of the processing unit 210.

The memory unit 220 is a working area for the processing unit 210 and provided by any memory such as an SRAM, a DRAM, or a ROM.

The communications unit 230 provides an interface for performing communications over a network and includes, for example, an antenna, an RF circuit, and a baseband circuit. The communications unit 230 communicates with the server system 100 over, for example, a network.

The display unit 240 provides an interface for displaying various information and may be a liquid crystal display device, an OLED display device, or a display device that operates under any other scheme. The operation unit 250 provides an interface for receiving user operations. The operation unit 250 may be, for example, a button on the terminal device 200. The display unit 240 and the operation unit 250 may be combined to form a touch panel.

### 2. Flow of Process

### 2.1 Overview of Flow

FIG. 4 is a flow chart representing a process performed by the information processing system 10 in accordance with the present embodiment. First of all, in step S101, the supply chain network acquisition section 111 acquires the supply chain network 121. The supply chain network acquisition section 111 stores the supply chain network 121 in the memory unit 120.

The input receiving section 112, in step S102, receives a user input operation. In this input operation, the user selects a company of interest. The user input operation may be performed on the operation unit 250 in the terminal device 200, in which case the input receiving section 112 acquires, for example, via the communications unit 130, information representing the input operation performed on the terminal device 200. Alternatively, the server system 100 may include an operation unit (not shown) so that the input receiving section 112 can receive an input operation performed on this operation unit. Specific implementation of the input operation can have many variations.

In step S103, the sub-network extraction section 113 extracts, as a sub-network, a part of the supply chain network that is related to a company of interest. The sub-network in this context includes either one or both of an upstream sub-network of upstream companies that supply a product to the company of interest and a downstream sub-network of downstream companies that receive a product from the company of interest. In the present embodiment, the “upstream” refers to a company/companies located on the starting end of an edge, in other words, a company/companies that provide(s) a product to another companies, whereas the “downstream” refers to a company/companies located on the terminating end of the edge, in other words, a company/companies that receive(s) a product from another company. The upstream companies include companies that provide a product directly to the company of interest. The upstream companies in the present embodiment may however include companies that are located upstream of another upstream company. In other words, the upstream companies may include companies linked to the company of interest via another company. Likewise, the downstream companies may include companies that receive a product directly from the company of interest and companies that are located downstream of another downstream company.

The company-of-special-interest identifying section 114, in step S104, performs a process of identifying a company of special interest in the extracted sub-network. The company of special interest will be described later in detail.

In step S105, the presentation processing section 115 performs a process of presenting a result of identifying a company of special interest. A result of identifying a company of special interest may contain various information on a company of special interest such as the presence/absence of a company of special interest, an attribute of the company of special interest, and/or a relationship between the company of special interest and the company of interest.

According to the technique in accordance with the present embodiment, the information processing system 10 performs a process of receiving a selection input of a company of interest and extracting a sub-network related to the company of interest from the supply chain network 121. For instance, as described above, the supply chain network 121 including many companies is generated from open information. Even if many companies are involved in complex business relationships, the supply chain network 121 can still be acquired, comprehensively reflecting these business relationships, because the business relationships are converted to node-linking edges. It is therefore possible to extract an appropriate sub-network representing the supply chain of each company of interest even if the selected company of interest changes. Conventional SCMs are capable of meticulously managing the supply chain of a particular company, but can only be applicable to the supply chain of that particular company. In contrast, the technique in accordance with the present embodiment is widely applicable to various companies of interest.

In addition, the present embodiment identifies a company of special interest in the extracted sub-network to present a result of such identification. For instance, the technique in accordance with the present embodiment is capable of determining whether or not the supply chain of a company of interest contains a company of special interest. By using a result of such determination, the technique can present to the user, for example, whether or not the supply chain contains a controversial company or whether or not the supply chain contains a company that is a choke point. The technique can hence prompt the user to take suitable actions such as choosing an alternative company to eliminate the choke point and/or cutting off the relationship with the inappropriate company. Additionally, the technique can nudge the user to recognize the specific relationship with the company of special interest, by presenting a path between the company of special interest and the company of interest. This configuration can provide information useful in devising a response strategy aimed at terminating the relationship with the company of special interest. For instance, when the supply chain of a company of interest possibly contains a disputed mine, the user can see a path between the two companies and infer whether or not the company of interest actually uses any mineral from the disputed mine.

A description is now given of differences from conventional techniques such as “Supply Chain Management by Manufacturing Companies in Japan,” by MATSUI Yoshiki, Yokohama Business Review, Vol. 29, No. 3 (September 2008), pages 205-220, by way of specific example. An example is taken where a raw material manufacturer refines a raw material, a component manufacturer manufactures components from the raw material, and a product manufacturer manufactures a product from the components. The component manufacturer is known to the product manufacturer because the component manufacturer trades directly with the product manufacturer. But, the product manufacturer may not know from what raw material the components are made. In this situation, in an SCM by a conventional technique, the sheer fact that the raw material manufacturer is a part of the supply chain is unknown, and the raw material manufacturer may not therefore be analyzed. Additionally, the supply chain, when including companies separated by a large distance (reached via a large number of edges) from the company of interest, greatly increases the complexity thereof. Conventional techniques may therefore have difficulty in accurately recognizing what companies are involved in the supply chain and what relationships the companies have. In other words, conventional techniques can have difficulty in searching for an unknown company of special interest and, as a logical consequence, also in identifying the relationship between the company of special interest and the company of interest.

In contrast, the technique in accordance with the present embodiment acquires the relatively large supply chain network 121 beforehand using, for example, open information and extracts a sub-network related to a company of interest from the supply chain network 121. The technique can therefore suitably include, in the analysis, companies that are not even known to persons related to the company of interest and/or to persons involved in the analysis. For instance, even if the user does not sufficiently know of the raw material manufacturer in the situation, the technique in accordance with the present embodiment is capable of suitably analyzing, for example, whether or not the product of the company of interest contains any illegal raw materials.

The processes performed by the information processing system 10 in accordance with the present embodiment may be partly or mostly provided by a program. In such cases, the information processing system 10 in accordance with the present embodiment is provided by a processor, such as a CPU, running the program. Specifically, a program stored in a non-transitory information recording medium is retrieved, and the retrieved program is run by a processor such as a CPU. The information recording medium (computer-readable medium or device) contains, for example, programs and data, and the functions thereof can be provided by, for example, an optical disc, a HDD, or a memory. The CPU or like processor implements various processes in accordance with the present embodiment on the basis of the program contained in the information recording medium. In other words, the information recording medium contains programs for causing a computer (device including an operation unit, a processing unit, a memory unit, and an output unit) to function as the units in accordance with the present embodiment.

The technique in accordance with the present embodiment is applicable to an information processing method in which the following steps are performed. The information processing method includes: acquiring the supply chain network 121, in which a plurality of nodes corresponding to a plurality of companies are linked, on the basis of a business relationship; receiving a selection operation of selecting any one of the companies as a company of interest; extracting, from the supply chain network 121, a sub-network including either one or both of an upstream sub-network including an upstream company that supplies a product to the company of interest and a downstream sub-network including a downstream company that receives a product from the company of interest; identifying a company of special interest that meets a given condition in the sub-network; and presenting information related to the company of special interest.

### 2.2 Acquisition of Supply Chain Network

A description is now given of a process corresponding to step S101 in FIG. 4 where the supply chain network 121 is acquired. The supply chain network acquisition section 111 may generate the supply chain network 121 on the basis of open information. The open information includes, for example, information such as securities reports and news releases.

The supply chain network acquisition section 111 identifies various information such as the name, nationality, business fields, business partners, and traded goods of each of many companies. The supply chain network acquisition section 111 may identify, for example, the number of employees, the shareholders and their capital contribution ratios, and the board members of each company on the basis of open information.

The supply chain network acquisition section 111 may additionally acquire reputation information representing reputation of each company on the basis of open information. For instance, the reputation information may indicate, for example, whether or not the target company is controversial in view of ESG (environment, social, governance) standards or whether or not the target company has ever been sanctioned. For instance, the reputation information may indicate, for example, whether or not the target company has ever violated export regulations, whether or not the target company trades disputed minerals, whether or not the target company is involved in forced labor, and/or whether or not the target company is engaged in illegal logging. The open information may be documents issued by governments or other organizations. The reputation information may indicate whether or not the target company is subject to trade regulations in, for example, a prescribed country. As described earlier, the open information may include SNS-related information, and the reputation information in this context may be determined on the basis of SNS. For instance, the supply chain network acquisition section 111 may acquire reputation information on the basis of the information supplied by an official SNS account of, for example, a company. The SNS information used in the technique in accordance with the present embodiment is not necessarily limited to the information supplied by an official account. For instance, if more than a prescribed number of users post the name of a given company with words such as “disputed minerals,” “forced labor,” and/or “illegal logging” over SNS, negative reputation information may be associated with the company.

FIGS. 5A and 5B show examples of the structure of the data acquired on the basis of open information. Referring to FIG. 5A, the supply chain network acquisition section 111 acquires information associated with the name, industrial class, reputation, and nationality of each company contained in open information.

The company name is, for example, text data representing the name of the target company. The industrial classification is information representing the business field of the target company. The reputation, as described above, is information representing, for example, whether or not the target company is controversial in view of ESG standards. The nationality is information representing the country to which the target company belongs.

FIG. 5A shows industry classes in text. Instead, the information representing industry classes may be given by industrial classification codes. For instance, in the Japan Standard Industrial Classification, for example, the code “231” is assigned to the primary nonferrous metal smelting and refining industry, and the code “2813” is assigned to the semiconductor device manufacturing industry. The industrial classification is not necessarily limited to the Japan Standard Industrial Classification. For instance, the industrial classification may be another classification such as the International Standard Industrial Classification or the NAICS (North American Industry Classification System). Various industrial classification codes may also be used in accordance with the industrial classification. For convenience of description, the following description assumes that the industrial classes are given by text representing the name of the class. However, the name of the class in the following process can be replaced with the industrial classification code. The memory unit 120 may also contain the industrial classification codes 122 as shown in FIG. 2. The industrial classification codes 122 are, for example, information that associates the names of classes to the classification codes in the Japan Standard Industrial Classification. The processing unit 110 may perform a process of conversion between the name of a class and a classification code on the basis of the industrial classification codes 122.

As shown in FIG. 5B, the supply chain network acquisition section 111 acquires information representing company-to-company transactions on the basis of open information. For instance, the business relationship information contained in the open information is information given in a format that enables identifying the information shown in FIG. 5B or the information shown in FIG. 5B. The information representing company-to-company transactions is, for example, information that associates information by which a sales source company is identified, information by which a sales destination company is identified, and information by which a product is identified.

On the basis of these types of information, the supply chain network acquisition section 111 generates the supply chain network 121 that is a directed graph with companies as nodes and business relationships as edges.

FIG. 5C is a diagram showing a part of an example of the supply chain network 121 generated on the basis of the business relationship shown in FIG. 5B. Referring to FIG. 5B, there is a relationship where company C1 sells product P1 to company C10. In this case, the supply chain network acquisition section 111 assigns an edge in the direction from C1 to C10 to a link between the node representing company C1 and the node representing company C10. The node representing company C1 is associated with the company name “C1” as well as information such as an industrial class, reputation, and nationality as shown in FIG. 5A. The same description applies to the node representing company C10. The edge from C1 to C10 is associated with traded product P1. The supply chain network acquisition section 111 may acquire information such as transaction volume and transaction price on the basis of open information and may associate these pieces of information with the edge.

There is also a relationship where company C10 sells product P2 to company C5 as shown in FIG. 5B. In this case, the supply chain network acquisition section 111 assigns an edge in the direction from C10 to C5 to a link between the node representing company C10 and the node representing company C5. Each node is associated with information shown in FIG. 5A, and each edge is associated with information related to, for example, a traded product.

As described above, in the supply chain network 121, which is a directed graph, the party that provides (sells) something is described as the “upstream,” and the party that receives (buys) something is described as the “downstream.” The terms, upstream and downstream, are defined in the same manner in sub-networks detailed later.

The supply chain network 121 in this context is, in a narrow sense of the term, a network of all nodes corresponding to any of the companies contained in open information to be processed. The supply chain network 121 therefore is a network including a large number of nodes. The number of nodes may be several thousand or even greater. The supply chain network 121 may be however constructed in various manners, for example, by excluding some companies included in the open information.

FIG. 6 is a schematic diagram of the supply chain network 121. Referring to FIG. 6, the supply chain network 121 is a directed graph in which a plurality of nodes is joined by edges representing business relationships. FIG. 6 shows the nodes in different shapes depending on, for example, whether the node represents a manufacturing factory or a distribution hub, to facilitate understanding. As described above, since the information such as the name and industrial class of each company corresponding to a node is already acquired, it is possible to perform a process of, for example, changing the display style in accordance with, for example, the industrial class. However, it is not essential to control the shape of the node in the technique in accordance with the present embodiment.

FIGS. 5A and 5B show exemplary data structures related to a supply chain network, and specific data structures are not limited to these examples. For instance, FIGS. 5A and 5B show examples where table data such as a relational database is used, but other data structures may be used. When table data is used, the number of tables is not limited to two. The data may be combined into one table or divided into three or more tables for management. Some of the items shown in FIGS. 5A and 5B may be omitted, and additional items may be added. For instance, the supply chain network acquisition section 111 may acquire information representing the company name, the industrial classification code, and the direction of buying and selling, while other information may be allowed to be omitted.

### 2.3 Extraction of Sub-Network

In the analysis related to a supply chain, it is important to analyze the network related to a predetermined company of interest by focusing on the company of interest. However, since the supply chain network 121 is a network acquired on the basis of, for example, open information, the supply chain network 121 contains numerous nodes and edges. The supply chain network 121 may therefore contain nodes and edges that are not related to the company of interest.

The input receiving section 112 therefore receives a selection input of a company of interest from a user in the present embodiment as shown in step S102 in FIG. 4. This process may allow the user who wants to conduct analysis to input, for example, a specific company name. Alternatively, the input receiving section 112 may perform a process of presenting candidates for the company of interest by receiving information such as industrial classes and products and searching using this information as search queries. The user selects a company of interest from the candidates presented, and the input receiving section 112 receives the selection input.

The sub-network extraction section 113 performs a process of extracting a sub-network related to the company of interest from the supply chain network 121 on the basis of the input operation received by the input receiving section 112.

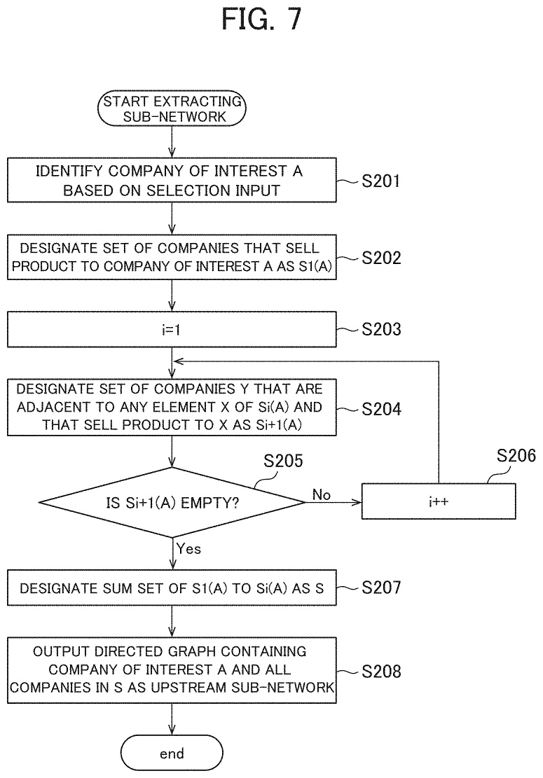

FIG. 7 is a flow chart illustrating a sub-network extraction process corresponding to step S103 in FIG. 4. In step S201, the sub-network extraction section 113 identifies a company of interest on the basis of the selection input received by the input receiving section 112. For instance, if the company name of the company of interest has been acquired, the sub-network extraction section 113 performs a process of identifying a company of interest on the basis of a comparison of this company name and the company name associated with each node of the supply chain network 121.

In step S202, the sub-network extraction section 113 selects all companies X that are adjacent to company of interest A and that sell something to the company of interest, and designates a set of these companies X as S1(A).

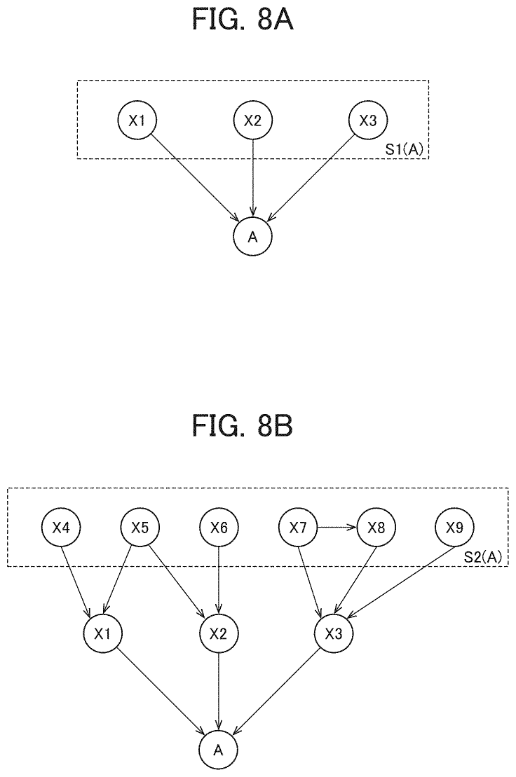

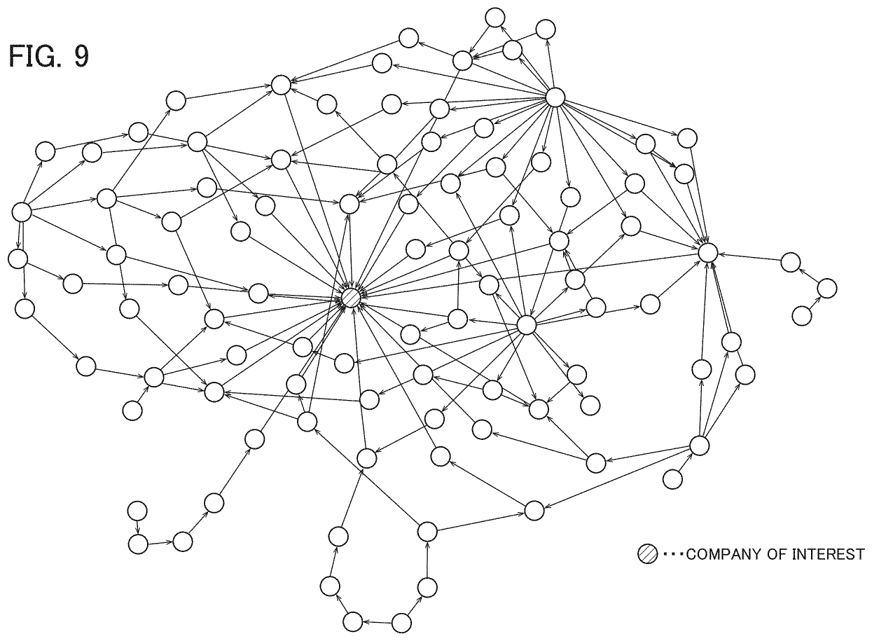

FIG. 8A is a diagram that shows an example of S1(A). For instance, FIG. 8(A) is a diagram that shows a part of the supply chain network 121 that contains company of interest A. In the example of FIG. 8A, the node representing company X1 is linked directly to the node representing company of interest A by an edge extending from X1 to A. In other words, X1 is adjacent to the company of interest and sells something to the company of interest, and is therefore determined to be an element of S1(A). Likewise, X2 and X3 are adjacent to the company of interest and sell something to the company of interest, and are therefore determined to be elements of S1(A). In this case, S1(A) is a set that contains three elements X1, X2, and X3.

In step S203, the sub-network extraction section 113 initializes a search variable i to 1.

In step S204, the sub-network extraction section 113 identifies every company Y that is adjacent to any element X of Si(A) and that sells a product to X, and designates a set of these companies Y as Si+1(A). When step S204 is executed for the first time on a given company of interest, i=1. Therefore, the sub-network extraction section 113 identifies every company Y that is adjacent to any element X of S1(A) and that sells a product to X, and designates a set of these companies Y as S2(A). Note that when step S204 is executed, Si+1(A) is first initialized to an empty set.

FIG. 8B is a diagram that shows an example of S2(A). S1(A) is, in this example, a set of three elements X1, X2, and X3 as described above with reference to FIG. 8A. The sub-network extraction section 113 first identifies company Y that is adjacent to X1 and that sells a product to X1. In this example, since two elements X4 and X5 meet the conditions, these two companies are added to S2(A). Next, the sub-network extraction section 113 identifies company Y that is adjacent to X2 and that sells a product to X2. In this example, although two elements X5 and X6 meet the conditions, since X5 has been previously added to S2(A), X6 is added to S2(A). Next, the sub-network extraction section 113 identifies company Y that is adjacent to X3 and that sells a product to X3. In this example, since three elements X7, X8 and X9 meet the conditions, these three companies are added to S2(A). Consequently, as shown in FIG. 8B, set S2(A) comes to contain six elements X4, X5, X6, X7, X8, and X9.

In step S205, the sub-network extraction section 113 determines whether or not Si+1(A) is an empty set. In the example of FIG. 8B, S2(A) contains six elements and is therefore not an empty set. It is hence determined that the process will follow the “No” path in step S205. In this case, the sub-network extraction section 113 increments the variable i in step S206 and returns the process to step S204.

For instance, the sub-network extraction section 113 identifies every company Y that is adjacent to any element X in S2(A) and that sells a product to X, and designates a set of these companies Y as S3(A). For instance, the sub-network extraction section 113 initializes S3(A) to an empty set. The sub-network extraction section 113 then identifies a company that is adjacent to X4 and that sells a product to X4, and adds the identified company to S3(A). The same description applies to X5 to X9. The sub-network extraction section 113 adds every company that is adjacent to another company and that sells a product to this other company to S3(A).

If S3(A) is not an empty set, the process returns again to step S204 to obtain S4(A). The same description applies to the subsequent process where steps S204 to S206 are repeated until Si+1(A) becomes an empty set.

Si+1(A) being an empty set in step S205 means that no element that meets the conditions is found in step S204, that is, no more upstream companies exist for companies X, which are elements of Si(A).

Therefore, in this case, in step S207, the sub-network extraction section 113 designates a sum set of S1(A), S2(A), . . . , and Si(A) as S.

In step S208, the sub-network extraction section 113 outputs, as a sub-network, a directed graph containing all the nodes that correspond to the company of interest and the companies contained in S. This sub-network, representing companies that are upstream of the company of interest, may be referred to as the upstream sub-network.

FIG. 9 shows an example of the upstream sub-network. Referring to FIG. 9, the upstream sub-network is a directed graph containing the nodes representing the companies directly or indirectly linked to the company of interest. In this manner, a part of the supply chain network 121 that is related to the company of interest can be extracted in a suitable manner. The upstream sub-network is information by which the companies contained in the supply chain of the company of interest and the specific link relationships between the company of interest and these companies can be identified. The upstream sub-network is therefore useful in the analysis of the supply chain of the company of interest.

In obtaining Si+1(A) in step S204, the sub-network extraction section 113 may identify company Y on the basis of a condition that company Y is not contained in a sum set of {A}, S1(A), . . . , and Si(A), as well as the conditions that company Y is adjacent to element X of Si(A) and sells something to X.

Suppose, as an example, that there is a circulation “Xa←Xb←Xc←Xa” for three companies Xa, Xb, and Xc, where Xa is an element of Si−2(A), Xb is an element of Si−1(A), and Xc is an element of Si(A). The expression, “Xa←Xb,” indicates that Xb is adjacent to Xa and sells something to Xa. In this case, although Xa is already an element of Si−2(A), Xa can be an element of Si+1(A) because Xa is adjacent to Xc and sells something to Xc. In other words, the sub-network extraction section 113 may need to perform complex processes if circulations are additionally taken into account. This concern is addressed, and the process can be simplified, by the addition of the condition that company Y is not contained in a sum set of {A}, S1(A), . . . , and Si(A) because this additional condition excludes Xa from the elements of Si+1(A).

The description above has discussed the upstream sub-network of companies that are upstream of the company of interest. The sub-network is however not limited to an upstream sub-network and may include a downstream sub-network.

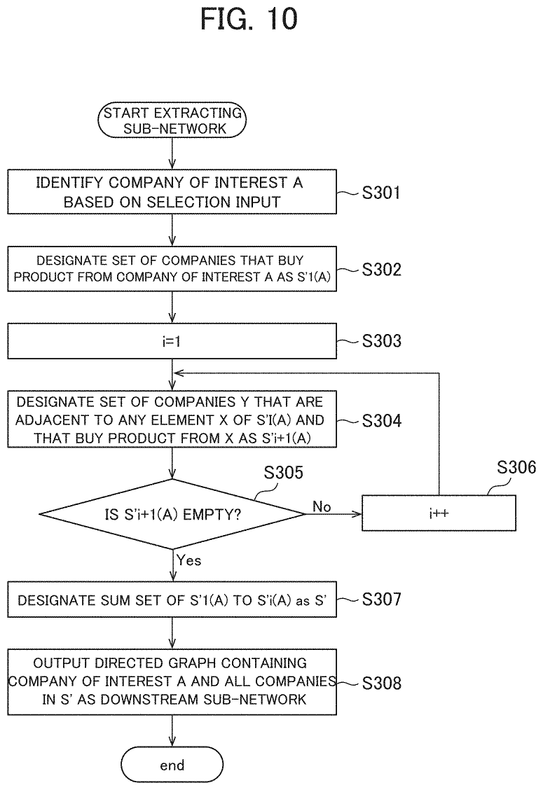

FIG. 10 is another flow chart of the sub-network extraction process corresponding to step S103 of FIG. 4. In step S301, the sub-network extraction section 113 identifies the company of interest on the basis of a selection input received by the input receiving section 112.

In step S302, the sub-network extraction section 113 selects all companies X that are adjacent to the company of interest and that buy something from the company of interest, and designates a set of these companies X as S′1(A). The process of obtaining S′1(A) is the same as in FIG. 8A, except for the directions of edges.

In step S303, the sub-network extraction section 113 initializes the search variable i to 1. In step S304, the sub-network extraction section 113 identifies every company Y that is adjacent to any element X of S′i(A) and that buys a product from X, and designates a set of these companies Y as S′i+1(A). The process of obtaining S′i+1(A) is the same as in the process of obtaining an upstream sub-network, except for the directions of edges, and detailed description is therefore omitted.

In step S305, the sub-network extraction section 113 determines whether or not S′i+1(A) is an empty set. If S′i+1(A) is not an empty set, the sub-network extraction section 113, in step S306, increments the variable i and returns the process to step S304. If S′i+1(A) is an empty set, the sub-network extraction section 113, in step S307, designates a sum set of S′1(A), S′2(A), . . . , and S′i(A) as S′.

In step S308, the sub-network extraction section 113 outputs, as a sub-network, a directed graph containing all the nodes that correspond to the company of interest and the companies contained in S′. This sub-network is a downstream sub-network representing companies that are downstream of the company of interest.

The sub-network in accordance with the present embodiment contains either one or both of the upstream sub-network and the downstream sub-network. In other words, the sub-network may be a sum set of A and S or a sum set of A and S′. The sub-network extraction section 113 may output both the upstream sub-network and the downstream sub-network. The sub-network extraction section 113 may output a sum set of A, S, and S′ as a sub-network.

### 2.4 Identifying Company of Special Interest

The sub-network extracted in the above-described process is information representing the supply chain of the company of interest. Complex relationships between many companies can be automatically summarized as a directed graph by acquiring the supply chain network 121 on the basis of, for example, open information. Since the sub-network is a subset of the supply chain network 121 that is related to the company of interest, the sub-network is useful in the analysis of the supply chain of the company of interest. For instance, the user can easily search manually for companies that are at a close distance from the company of interest. The user may however find it difficult to manually search for companies that are located remotely, but that may possibly be linked to the company of interest, because the scope of search rapidly increases with increasing distance. This concern is addressed by the sub-network in accordance with the present embodiment that enables readily identifying companies related to the company of interest regardless of the distance separating the companies from the company of interest. Therefore, the sub-network in accordance with the present embodiment enables the user to recognize, for example, that the user has an unintended relationship with a given company.

In so doing, all companies but the company of interest may be handled uniformly as shown in FIG. 9. In the present embodiment, however, a company of special interest, or one of these companies that needs a special attention, may be identified. A description is given next of a process, of identifying a company of special interest, that corresponds to step S104 of FIG. 4.

For instance, the company-of-special-interest identifying section 114 may perform a process of identifying a company that is likely a choke point in the sub-network as a company of special interest. In this context, the sub-network is an upstream sub-network in a narrow sense of the term. A choke point is such a node on a path linking two communities that without this node, either all links between the two communities would be cut off or that the only remaining link would have a vastly increased path length. To quantitatively evaluate this, “medium centrality,” which is one of measures termed “centrality measures” is defined next as a measure for measuring the choke-point likelihood. Assume that there are two communities X and Y containing elements x and elements y respectively. For any combination of elements x and y, a node is determined that is on a minimum distance path linking x and y. The proportion at which a given node appears on the minimum distance path when all combinations of x and y are taken into account is defined by some method, and this is designated as the medium centrality of the node. In this context, a community is generally a set of closely linked nodes. To mathematically calculate the choke-point likelihood, a set of one or more identified nodes may be defined as a community. This technique is disclosed in, for example, “A Faster Algorithm for Betweenness Centrality”, by Ulrik Brandes, Journal of Mathematical Sociology 25(2), 2001, page 163-177. A node with a very high medium centrality qualitatively has the properties of a choke point in the original sense of the term “choke point”. The company-of-special-interest identifying section 114 may identify a company that has a high choke-point likelihood, on the basis of, for example, the medium centrality measure defined above.

For example, if there is a company that is a choke point in the upstream sub-network, the company of interest may not be able to procure, for example, raw materials in a proper manner when the company of interest can no longer continue trading with the company. By identifying a company that has a high choke-point likelihood, it becomes possible to suitably check the presence/absence of such a risk in the trade and the scale of the risk.

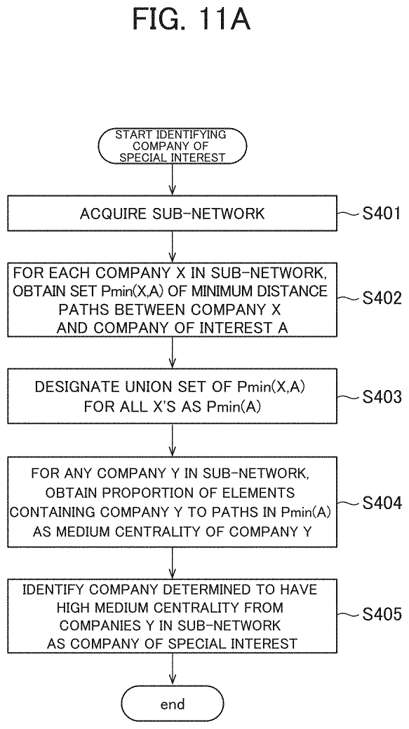

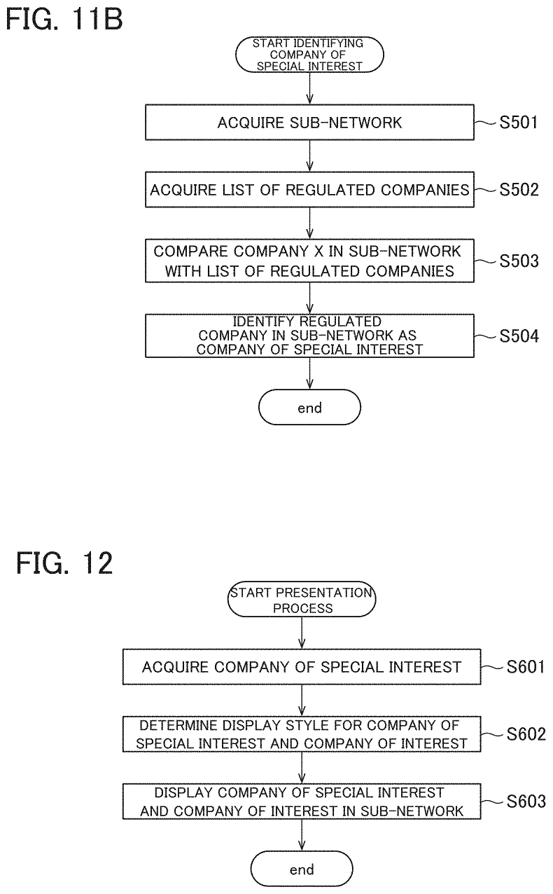

FIG. 11A is a flow chart of a process of identifying a company that has a high choke-point likelihood as a company of special interest. In step S401, the company-of-special-interest identifying section 114 acquires a sub-network. For instance, the company-of-special-interest identifying section 114 acquires an upstream sub-network as a sub-network. This is an example of calculating a medium centrality on the assumption that in the above-described definition, one of the two communities is a set {A} containing only companies of interest A and nothing else, and the other community is a set of all companies X in the acquired sub-network, other than A.

In step S402, for each company X in the acquired sub-network, the company-of-special-interest identifying section 114 obtains a set P min(X,A) of minimum distance paths between X and the company of interest. To analyze the upstream sub-network, P min(X,A) represents a set of some of the paths with X as the starting end and A as the terminating end that have a minimum distance. Attention should be paid to the fact that generally there exists a plurality of minimum distance paths. However, there may be only one minimum distance path that has given company X as the starting end and A as the terminating end, depending on the structure of the sub-network. Various techniques are known by which the minimum distance path is obtained in a directed graph, and these techniques are widely applicable to the present embodiment, and detailed description is therefore omitted.

In step S403, the company-of-special-interest identifying section 114 designates a union set of P min(X,A) for all X's as P min(A). As an example, if the sub-network is a directed graph containing m nodes corresponding to companies X1 to Xm respectively as well as company of interest A, P min(A) is a union set of m minimum distance path sets P min(X1,A) to P min(Xm,A), where m is an integer greater than or equal to 2.

In step S404, for each company Y in the acquired sub-network, the company-of-special-interest identifying section 114 computes, as a medium centrality of company Y, a proportion of the elements of P min(A) containing company Y to all the elements of P min(A). The proportion can be calculated by one of several known techniques. The simplest one of these techniques is used in this example, where the proportion is calculated by dividing the number of the elements of P min(A) containing company Y by the number of the elements of P min(A).

In step S405, the company-of-special-interest identifying section 114 identifies a company determined to have a high medium centrality among the companies in the sub-network as a company of special interest. The company-of-special-interest identifying section 114 may identify, for example, a prescribed number of companies with the largest medium centrality values among the companies in the sub-network as a company of special interest. The prescribed number in this context does not necessarily have a fixed value and may be varied in accordance with, for example, the number of companies in the sub-network. As another alternative, the company-of-special-interest identifying section 114 may identify a company that has a medium centrality value larger than a given threshold value among the companies in the sub-network as a company of special interest.

The description above has discussed an example where the sub-network is an upstream sub-network. Alternatively, the sub-network may be a downstream sub-network as described earlier. To analyze the downstream sub-network, the same description is applicable as to the above-described example, except for P min(X,A) has A as the starting end and X as the terminating end. It should be noted however that a choke point in an upstream sub-network is more important than a choke point in a downstream sub-network in that the former can be related to an issue as to whether or not company of interest A can get a suitable supply of raw materials. The company-of-special-interest identifying section 114 in accordance with the present embodiment may therefore perform a process of identifying a company that has a high choke-point likelihood as a company of special interest in the analysis of an upstream sub-network and not identifying a company that has a high choke-point likelihood in the analysis of a downstream sub-network as a company of special interest.

As a further alternative example, the sub-network may contain both an upstream sub-network and a downstream sub-network. When this is the case, the company-of-special-interest identifying section 114 may compute a centrality measure by using both the upstream sub-network and the downstream sub-network. For instance, similarly to the above example, for each company X in the sub-network, the company-of-special-interest identifying section 114 obtains a minimum distance path P min(X,A) between X and the company of interest and designates an X-related union set of P min(X,A) as P min(A). The company-of-special-interest identifying section 114 computes the proportion of the elements of P min(A) containing company X to all the elements of P min(A) as the medium centrality for company X. For instance, in a case where a sub-network containing a circulation is acquired such as a case where a company in the downstream sub-network sells something to a company in the upstream sub-network, a different centrality measure may be possibly computed if both the upstream sub-network and the downstream sub-network are used than if any one of the upstream sub-network and the downstream sub-network is used.

Alternatively, the company-of-special-interest identifying section 114 may obtain a minimum distance path for each pair of any two nodes in a sub-network including both the upstream sub-network and the downstream sub-network. The company-of-special-interest identifying section 114 then obtains the proportion of the number of the minimum distance paths having a given node thereon to the total number of the minimum distance paths as a medium centrality. The company-of-special-interest identifying section 114 may identify, for example, a company determined to have a high medium centrality among the companies in the sub-network other than the company of interest as a company of special interest. When this is the case, the centrality measure is computed differently from the process described above with reference to FIG. 11A because those paths where the company of interest does not serve as an end are also analyzed.

For instance, the company-of-special-interest identifying section 114 may be capable of switching between a first process of identifying a company that has a high choke-point likelihood as a company of special interest on the basis of a first index obtained using the upstream sub-network and a second process of identifying a company that has a high choke-point likelihood as a company of special interest on the basis of a second index obtained using both the upstream sub-network and the downstream sub-network. This configuration enables switching between multiple processes with different centrality measure values, therefore enabling the use of a centrality measure that is better suited to, for example, the situation in identifying a company of special interest. Consequently, the sub-network analysis can be performed in a more suitable manner. Also, as described above, the company-of-special-interest identifying section 114 may be capable of performing a third process of identifying a company that has a high choke-point likelihood as a company of special interest on the basis of a third index obtained using the downstream sub-network. When this is the case, the company-of-special-interest identifying section 114 may be capable of switching between the first process, the second process, and the third process in accordance with the situation.

FIG. 11A shows an example where the medium centrality is used as a centrality measure for measuring the choke-point likelihood. However, other information may be used as a centrality measure. As an example, the company-of-special-interest identifying section 114 may obtain an order centrality as a centrality measure to designate a company determined to have a high order centrality as a company of special interest. This order represents the number of edges connected to each node, and the order centrality is such a measure that a higher order is translated into a higher centrality. Centrality measures other than the medium centrality and the order centrality are also known in graph theory and may be used as the centrality measure in the present embodiment.

The company-of-special-interest identifying section 114 may perform a process of identifying a company determined to be inappropriate to trade with on the basis of reputation information, using either one or both of the upstream sub-network and the downstream sub-network, as a company of special interest. As an example, open information contains reputation information of each company, and this reputation information is associated with a node in the supply chain network and the sub-network as shown in FIG. 5A. The reputation information contained in open information and the reputation information associated with a node may be the same information or may be different information. For instance, a result of some process performed on the reputation information contained in open information may be associated with a node, and the reputation information in the present embodiment may include a broad range of processed and unprocessed information. For instance, the company-of-special-interest identifying section 114 identifies as a company of special interest, for example, a company that has ever violated export regulations, a company that trades a disputed mineral, a company that is involved in forced labor, and/or a company that is engaged in illegal logging. This configuration enables identifying a company with which the user should not have a business relationship as a company of special interest, therefore enabling the user to determine in a suitable manner, for example, whether or not the user has an unintended relationship with controversial companies.

For instance, the memory unit 120 in the server system 100 may contain a list of companies determined to be controversial on the basis of open information as the list of regulated companies 124.

FIG. 11B is a flow chart of a process of identifying a controversial company as a company of special interest. In step S501, the company-of-special-interest identifying section 114 acquires a sub-network. For instance, the company-of-special-interest identifying section 114 acquires an upstream sub-network as the sub-network.

In step S502, the company-of-special-interest identifying section 114 retrieves the list of regulated companies 124 from the memory unit 120. In step S503, the company-of-special-interest identifying section 114 compares each company in the sub-network with the list of regulated companies 124 to determine whether or not the company is regulated in their activities or otherwise controversial.

In step S504, the company-of-special-interest identifying section 114 identifies, as a company of special interest, a company in the sub-network that is also found on the list of regulated companies 124.

In this example, the list of regulated companies 124 is generated on the basis of reputation information, which does not limit the process in accordance with the present embodiment. In another example, the company-of-special-interest identifying section 114 may acquire reputation information by referring to the information shown in FIG. 5A for each company in the sub-network. The company-of-special-interest identifying section 114 determines whether or not each company is a company of special interest, on the basis of the reputation information.

### 2.5 Presentation Process

The presentation processing section 115 performs a process of presenting a result of identifying a company of special interest. As an example, if the company of special interest is determined to have a high choke-point likelihood or to be otherwise controversial, the presence of the company of special interest poses a risk in proper trading and the stable procurement of, for example, raw materials. In other words, the company of special interest can be a measure for evaluating the safety of the supply chain. The presentation processing section 115 may therefore perform a process of presenting a result of evaluation of the safety of the sub-network on the basis of the result of identifying the company of special interest. For instance, the presentation processing section 115 may present information representing the presence/absence of a company of special interest as information representing the safety of the sub-network. This configuration enables presenting to the user whether or not there is a link to a controversial company. Alternatively, the presentation processing section 115 presents, as information representing the safety of the sub-network, information containing the identified companies of special interest sorted on the basis of the value of centrality measure. This configuration enables the presentation of the presence/absence of a company that has a high choke-point likelihood and the degree thereof. Consequently, the user, provided with the presentation, can learn about the safety of the supply chain of the company of interest and hence, for example, review the supply chain to improve the safety.

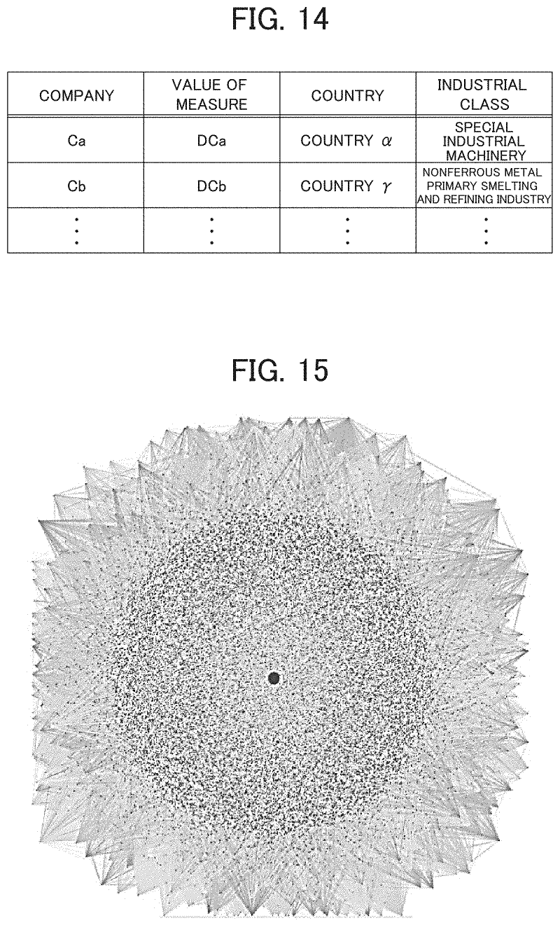

Considering the idea of presenting safety, the presentation processing section 115 may display the presence/absence of a company of special interest. Alternatively, the presentation processing section 115 may display a list of companies of special interest as will be described later in detail with reference to FIG. 14. As another alternative, the presentation processing section 115 may perform a process of displaying companies of special interest and companies of interest in the sub-network. This configuration enables clearly displaying the locations of companies of interest and companies of special interest in the sub-network and thereby presenting the relationships therebetween to the user in an easy-to-understand manner. Specific examples are escribed below.

FIG. 12 is a flow chart of a presentation process corresponding to step S105 of FIG. 4. In step S601, the presentation processing section 115 acquires information representing the companies of special interest identified in the processes shown in FIGS. 11A and 11B.

In step S602, the presentation processing section 115 performs a process of determining the display style of the companies of special interest and the companies of interest. For instance, the presentation processing section 115 performs a process of setting the display style of the companies of interest among the nodes in the sub-network to a first mode, the display style of the companies of special interest to a second mode, and the display style of the other companies to a third mode. These first to third modes need only to be distinguishable from each other and may display nodes in different shapes, different colors, or different sizes or in any combination thereof.

In step S603, the presentation processing section 115 performs a process of displaying the companies of interest and the companies of special interest in distinguishable modes in the sub-network. Specifically, the presentation processing section 115 performs a process of displaying the companies of interest, the companies of special interest, and the other companies in different modes on the basis of step S602.

FIG. 13 shows an exemplary screen displayed in step S603. The sub-network in this context is the same as in the example described above with reference to FIG. 9. FIG. 13 shows the companies of interest, the companies of special interest, and the other companies the respective nodes associated with which are displayed in different patterns. Therefore, the locations of the companies of interest and the companies of special interest can be easily recognizable visually in the sub-network, and the relationships therebetween can be presented to the user in an easy-to-understand manner.

The information displayed in the present embodiment is not limited to this. Alternatively, as an example, when a plurality of companies of special interest is identified, the presentation processing section 115 may display a list of these companies of special interest.

FIG. 14 shows an example of a list of companies of special interest. For instance, the companies of special interest in this context have a high choke-point likelihood. In this case, the list contains information by which, for example, the company name, the centrality measure value, the nationality, and the industrial class are associated. Displaying such a list enables presenting information related to the company of special interest in the sub-network to the user in a highly comprehensive manner. Since the example in FIG. 14 presents information related to the attributes of each company, variations are also possible in which, for example, the display target is limited to companies of a specific nationality on the basis of a user input.

The presentation processing section 115 may perform a process of displaying paths between a company of special interest and the companies of interest as a result of identifying the company of special interest. The paths in this context are, for example, minimum distance paths between the company of special interest and the companies of interest. For instance, when P min(A) is already available in the process of obtaining a centrality measure, P min(Z,A) may be repurposed for a minimum distance path to given company of special interest Z. Alternatively, the presentation processing section 115 may perform a process of computing the minimum distance path. Since generally there exists a plurality of minimum distance paths, all these paths may be displayed simultaneously, or alternatively the paths may be displayed one at a time. Other display methods are also possible, and the display method is not limited.

The presentation processing section 115 may perform a process of simultaneously displaying a plurality of minimum distance paths obtained respectively for a plurality of companies of special interest in the sub-network shown in, for example, FIG. 13. Alternatively, the presentation processing section 115 may perform a process of only presenting a minimum distance path related to some select companies of special interest, on the basis of a user input of selecting those companies of special interest from a plurality of companies of special interest. A company of special interest may be selected using a screen shown in FIG. 13 where the sub-network is displayed or using a screen shown in FIG. 14 where a list of companies of special interest is displayed. Displaying paths between the company of special interest and the companies of interest enables presenting specific links between the company of special interest and the companies of interest in a highly visually recognizable manner. In particular, a shorter path tends to represent an efficient trade in supply chains. In other words, a minimum distance path between two companies will likely represent the actual trade route between the two companies in comparison to other paths. The presentation of a minimum distance path is therefore useful.

The company of special interest may include a plurality of types of companies in the present embodiment. As an example, the company of special interest includes companies that have a high choke-point likelihood and companies that are controversial in view of ESG standards. In this case, the presentation processing section 115 may modify the display style of the target company of special interest in accordance with the type of the company of special interest. For instance, the companies of special interest that have a high choke-point likelihood are displayed in a fourth mode, and the companies that are determined to be controversial are displayed in a fifth mode. The fourth mode may be further divided in accordance with the magnitude of the centrality measure. Alternatively or additionally, the fifth mode may be further divided in accordance with the specific nature of the controversy. For instance, the presentation processing section 115 may perform a process of displaying the companies that violated export regulations, the companies that trade disputed minerals, the companies that are involved in forced labor, and the companies that are engaged in illegal logging in different modes respectively.

### 3. Variation Examples

The following will describe some variation examples.

### 3.1 Narrowing Conditions

FIG. 15 shows an example of the sub-network of a given company of interest. In FIG. 15, a line segment denotes an edge, and a point denotes a node. In the example shown in FIG. 15, there are so many companies possibly contained in the supply chain that the links between the companies are highly complex. For example, if, for example, companies involved in large-scale business and/or companies involved in international trades are selected as companies of interest, the sub-network can be complex as shown in FIG. 15.

When a sub-network is acquired that resembles the sub-network shown in FIG. 15, it is not easy to make the user recognize specific companies and links between companies if the entire sub-network is to be presented. Meanwhile, if the individual nodes and edges are scaled up such that the nodes and edges are visually recognizable, it may be difficult to recognize the entire sub-network because only a very small portion of the sub-network can be displayed. In addition, the nodes that are closely located on the display do not always represent highly related companies (e.g., the companies belong to similar industry sectors or trade similar products). Simply scaling up a part of the sub-network may not be useful in analyzing the sub-network.

Accordingly, the present embodiment may involve narrowing down the number of companies. Specifically, the sub-network extraction section 113 may narrow down the number of companies in the sub-network. Alternatively, the company-of-special-interest identifying section 114 and the presentation processing section 115 may narrow down the number of target companies in the process of identifying a company of special interest and the process of displaying a result of identifying such a company.

### First Narrowing Condition in Extracting Sub-Network

For instance, the sub-network extraction section 113 extracts a sub-network on the basis of first narrowing information containing either one or both of product information by which a traded product is identified and industry sector information by which an industry sector is identified. This configuration enables limiting the number of companies contained in the sub-network. Specifically, the companies that do not meet the first narrowing condition represented by the first narrowing information can be excluded from the sub-network. Consequently, the sub-network has a simple structure than in a case where the first narrowing condition is not used, which enables reducing the load of the process using the sub-network and presenting suitable information to the user.

The industry sector information here represents a field of business and, as an example, is in accordance with industrial classification such as the Japan Standard Industrial Classification. The product information represents a traded product that a given company sells as a commercial product to another company. The traded product represents the goods to be traded and includes a wide variety of goods from materials to components to manufacturing machines.

As an example, consider an example where the company of interest is a manufacturer of semiconductor devices such as ICs. Various semiconductor materials such as silicon wafers, photoresist, etching gas, and sealing material are needed to manufacture semiconductor devices. Additionally, manufacturing steps including photolithography, thermal processing, etching, and cleaning require dedicated semiconductor manufacturing machines respectively. Inspection is done in a post-manufacturing process, which also uses semiconductor inspection machines.

Thus, when targeting a supply chain related to semiconductors, it is possible to limit the products distributed in the supply chain to some extent. Specifically, products such as silicon wafers, photoresist, etching gas, sealing material, semiconductor manufacturing machines, and semiconductor inspection machines are distributed as described earlier.

The company of interest in the example described above is a company that manufactures CPUs, memory devices, and like semiconductor devices and therefore belongs to the “semiconductor device manufacturing industry.” In this case, it is also possible to limit the industry sectors of the companies in the supply chain of the company of interest. For instance, in terms of the Japan Standard Industrial Classification, the upstream companies in the “semiconductor device manufacturing industry” include companies classified into the “nonferrous metal primary smelting and refining industry,” the “industrial inorganic chemical products,” the “special metal dies and related products,” and the “special industrial machinery.”

When the company of interest is related to semiconductors, and the analysis is aimed at a semiconductor supply chain related to the company, it is useful to take these industry sectors and products into account in the process. However, if one only considers that the company has a business relationship on the basis of open information, the sub-network could contain companies that are not at all related to semiconductors.

For example, consider the case where the company of interest purchases a semiconductor manufacturing machine from a manufacturing machine manufacturer and also that the manufacturing machine manufacturer purchases food ingredients for an employee cafeteria thereof from a food-related company. In this case, since the manufacturing machine manufacturer and the food-related company have a business relationship, the nodes representing the two companies are linked by an edge in the supply chain network 121. Consequently, the nodes representing the company of interest and the food-related company are indirectly linked. It is however unlikely that the food-related company could have a significant impact on the semiconductor supply chain. Even if the food-related company is subject to regulations, the semiconductor manufacturing machines purchased by the company of interest will unlikely contain a product (food ingredient) supplied by the food-related company, and the impact on the company of interest should be low. In other words, the food-related company hardly needs to be considered from the perspective of semiconductor supply chain analysis.

The first narrowing condition in the present embodiment is a condition under which companies with low importance are excluded from the supply chain analysis regarding the industry sector or product to be analyzed. For example, the first narrowing information represents the industry sectors of, or the products traded by, the companies to be excluded from the sub-network extraction process. The first narrowing information may be, for example, information inputted by the user.

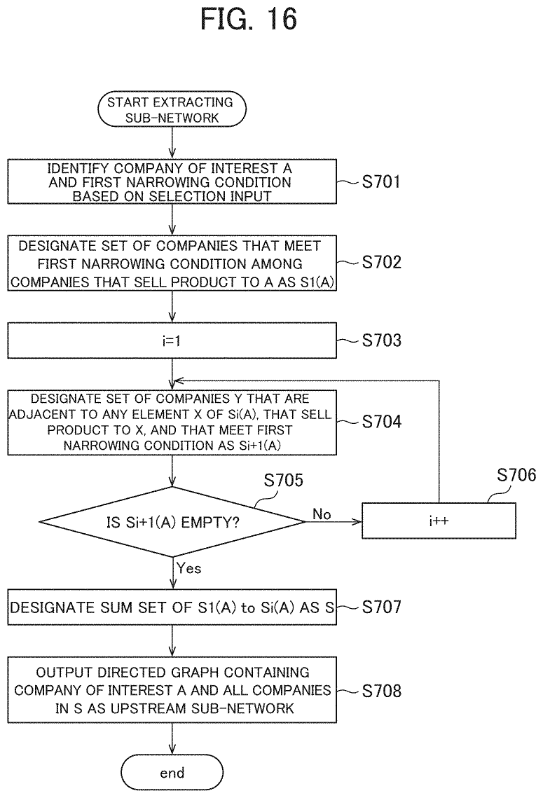

FIG. 16 is a flow chart of a sub-network extraction process using the first narrowing information. In step S701, the sub-network extraction section 113 identifies the company of interest and the first narrowing condition on the basis of the user input received by the input receiving section 112. For instance, if the user wants to acquire a result of semiconductor supply chain analysis, the user inputs industry sectors such as “food and beverage wholesalers” or products such as “foods” and “beverages” as an exclusion target, and the input receiving section 112 acquires an input result as the first narrowing information.

In step S702, the sub-network extraction section 113 selects all companies X that are adjacent to company of interest A, that sell something to company of interest A, and that meet the first narrowing condition, and designates a set of these selected companies as S1(A). In the example described above, the sub-network extraction section 113 selects companies that sell something to the company of interest and whose industrial class is not the “food and beverage wholesaler.” Alternatively, the sub-network extraction section 113 selects companies that sell something to the company of interest and that trades a product that is neither a “food” nor a “beverage.”

As described above, industry sectors (industrial classes) are associated with nodes in the supply chain network 121, whereas traded products are associated to edges in the supply chain network 121. The sub-network extraction section 113 can perform step S702 by using these pieces of information.

In step S703, the sub-network extraction section 113 initializes the search variable i to 1.

In step S704, the sub-network extraction section 113 identifies companies Y that are adjacent to any element X of Si(A), that sell a product to X, and that meet the first narrowing condition, and designates a set of these companies Y as Si+1(A). In other words, the companies that meet the first narrowing condition are also targeted for selection in the process of sequentially identifying, for example, S2(A) and S3(A).

The process shown in steps S705 to S708 is the same as steps S205 to S208 in FIG. 7, and detailed description is therefore omitted. The process in FIG. 16 limits the companies in the upstream sub-network on the basis of the first narrowing information, thereby restraining the sub-network from being excessively complex. That in turn enables, for example, reducing the load of subsequent processes including the process of identifying a company of special interest. FIG. 16 shows an example where an upstream sub-network is extracted. The first narrowing information can also be used in a downstream sub-network extraction process. For example, when the downstream sub-network of a semiconductor device manufacturer is considered, the industry sectors or products are excluded that are highly related to the distribution of products such as ICs and memory devices.

The specifics and flow of process related to the first narrowing information are not necessarily limited to those described above, and a wide range of variations is possible.

For example, the first narrowing information is not limited to information by which the industry sectors and products to be excluded are identified and may be information by which the industry sectors and products to be included in the sub-network are identified. For example, in the case of a semiconductor supply chain, the first narrowing information may be a set of semiconductor-related industry sectors such as the “semiconductor device manufacturing industry,” the “nonferrous metal primary smelting and refining industry,” the “industrial inorganic chemical products,” the “special metal dies and related products,” and the “special industrial machinery.” The first narrowing information may also be a set of semiconductor-related products such as semiconductor materials, semiconductor manufacturing machines, and semiconductor inspection machines.

The technique in accordance with the present embodiment is not necessarily limited to the user having to input the first narrowing information per se. The process of identifying the first narrowing information may be partially or totally automated.

For example, the memory unit 120 may contain information representing the degree of relevance for each industrial class as the industry- and product-specific knowledge database 123. For example, the industry- and product-specific knowledge database 123 may be a set of data representing the degree of relevance between a given industrial class in the Japan Standard Industrial Classification and another industrial class. In the example described above, information that the degree of relevance is low between the industrial classes such as the “semiconductor device manufacturing industry,” the “nonferrous metal primary smelting and refining industry,” the “industrial inorganic chemical products,” the “special metal dies and related products,” and the “special industrial machinery” and the “food and beverage wholesaler” is associated.

Likewise, the industry- and product-specific knowledge database 123 may contain information representing the degree of relevance for each product. For example, the information that the degree of relevance is low between products such as semiconductor devices, semiconductor materials, and semiconductor manufacturing machines and foods is associated.

The sub-network extraction section 113 identifies the first narrowing information on the basis of the industry- and product-specific knowledge database 123 and extracts a sub-network so as to meet the first narrowing condition represented by the first narrowing information,. For instance, when the user inputs an industrial class, “semiconductor device manufacturing industry,” the sub-network extraction section 113 may select, as an exclusion target, an industrial class that has a low degree of relevance with the industrial class such as the “food and beverage wholesaler.” Alternatively, the sub-network extraction section 113 may select, as an extraction target, industrial classes that have a high relevance with the “semiconductor device manufacturing industry” such as the “nonferrous metal primary smelting and refining industry,” the “industrial inorganic chemical products,” the “special metal dies and related products,” and the “special industrial machinery.”

In this case, the user inputs may be strictly in accordance with the standard industrial classification or any keyword such as “semiconductor.” For example, the sub-network extraction section 113 may identify the industrial class, “semiconductor device manufacturing industry” from the keyword, “semiconductor” to perform a process of obtaining the degree of relevance with this industrial class. Alternatively, the industry- and product-specific knowledge database 123 itself may be information by which keywords are associated with industrial classes to be excluded. As an example, the industry- and product-specific knowledge database 123 contains data that associates a keyword, “semiconductor,” to an industrial class to be excluded, “food and beverage wholesaler”. As an alternative example, the industry- and product-specific knowledge database 123 may be information that associates a keyword to an industrial class to be extracted.

As shown in FIG. 5A, the attributes of each company may be identified on the basis of open information. For instance, the sub-network extraction section 113 may identify the first narrowing information on the basis of an attribute of a company of interest. For instance, if the attribute of a company of interest includes an industrial class, “semiconductor device manufacturing industry,” the sub-network extraction section 113 may perform a process of selecting industrial classes that have a low degree of relevance with the industrial class as an exclusion target or a process of selecting industrial classes that have a high degree of relevance with the industrial class as an extraction target.

When the first narrowing condition is used, it is not desirable to make the condition excessively strict. Specifically, if the industry sectors and products to be extracted are narrowed down to a small number, it may not be possible to properly extract a sub-network.

For instance, in the semiconductor supply chain, silicon wafers are supplied to semiconductor device manufacturers after silicon mining, refining, and processing. These steps may possibly carried out by different companies respectively. For instance, company 1 in the “non-metal mining industry” performs the mining, company 2 in the “nonferrous metal primary smelting and refining industry” performs the refining, and company 3 in the “other electronic component, device, and electronic circuit manufacturing industry” performs the processing into silicon wafers. Semiconductor device manufacturers purchase silicon wafers from company 3.

Here, we consider analyzing whether or not a semiconductor device manufacturer uses silicon acquired through illegal mining as a raw material for their products. If the first narrowing condition is specified so as to extract only the “non-metal mining industry” and exclude, among others, the “nonferrous metal primary smelting and refining industry” and the “other electronic component, device, and electronic circuit manufacturing industry,” it may not be possible to properly extract a sub-network. In the example described above, company 1 trades with company 2, and the company of interest trades with company 3, whereas the company of interest does not trade directly with company 1. Therefore, if the process shown in FIG. 16 is performed, it may be determined in step S702 that there is no company that is adjacent to the company of interest, that sells something to the company of interest, and that meets the first narrowing condition (that belongs to the “non-metal mining industry”).

In the technique in accordance with the present embodiment, it is also important to determine whether or not the supply chain (sub-network) of the company of interest unintentionally includes a company of special interest. For this purpose, it may be preferable in the extraction of a sub-network to focus on restraining failures in detecting a company of special interest, rather than on excessively limiting the number of companies.

In light of the above, the first narrowing information is somewhat mild. For example, the number of industry sectors and products to be extracted may be large. As an example, the first narrowing condition may exclude only the industry sectors and products that have a relevance less than or equal to a prescribed level and include all the other industry sectors and products, as described above.

### Second Narrowing Condition in Identifying and Presenting Company of Special Interest

The company-of-special-interest identifying section 114 may also identify a company of special interest in a sub-network on the basis of second narrowing information containing either one or both of product information and industry sector information as well as on the basis of a given condition. Similarly to the first narrowing information, the industry sector information represents a field of business and, as an example, is in accordance with industrial classification such as the Japan Standard Industrial Classification. Also similarly to the first narrowing information, the product information represents a traded product that a given company sells as a commercial product to another company. The given condition indicates that the choke-point likelihood is determined to be high and/or the trades are determined to be controversial, as described above.

This configuration enables narrowing down the number of companies of special interest. Compared to a case where the second narrowing information is not used, the configuration can reduce the number of companies of special interest displayed in the list or the number of companies of special interest displayed on the sub-network, thus making it possible to present the results of the analysis to the user in an easy-to-understand manner.

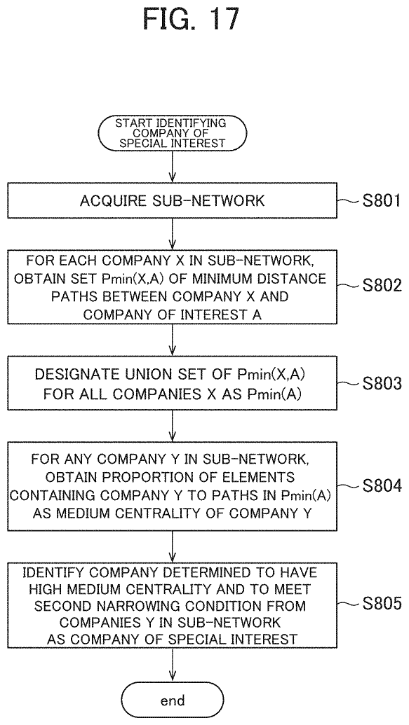

FIG. 17 is a flow chart of a process of identifying a company of special interest by using the second narrowing information. Steps S801 to S804 are the same as steps S401 to S404 in FIG. 11A. In other words, the acquisition of a sub-network, the calculation of a minimum distance path in the sub-network, and the computation of a centrality measure are the same as in when the second narrowing information is not used.

In step S805, the company-of-special-interest identifying section 114 identifies, as a company of special interest, a company that is determined to have a high medium centrality and that also meets the second narrowing condition. When the second narrowing information is not used, the industrial classes to which companies with a high centrality measure belong could include various classes such as the “special industrial machinery” and the “primary nonferrous metal smelting and refining industry” as shown in, for example, FIG. 14. In the process shown in FIG. 17, since the company-of-special-interest identifying section 114 uses not only the centrality measure, but also the second narrowing condition, the company of special interest is more limited. As an example, suppose that the second narrowing information is to extract the “primary nonferrous metal smelting and refining industry.” In such a case, the company-of-special-interest identifying section 114 identifies, as a company of special interest, a company that has a high centrality measure and that also belongs to the “primary nonferrous metal smelting and refining industry.” For instance, in FIG. 14, company Ca is determined to not be a company of special interest, and company Cb is determined to be a company of special interest.

For instance, a semiconductor supply chain could include companies classified into, for example, the “nonferrous metal primary smelting and refining industry,” the “industrial inorganic chemical products,” the “special metal dies and related products,” and the “special industrial machinery” as described above. If all these are targeted in the extraction of a company of special interest, information on various industry sectors would be mixed. Consequently, the target of the presentation process could be a network as complex as the one shown in FIG. 15. However, the use of the second narrowing information enables extracting information related to specific industrial classes out of these various industrial classes, thus making it possible to present information related to a company of special interest to the user in an easy-to-understand manner. Although FIG. 17 shows an example where a company that has a high choke-point likelihood is identified as a company of special interest, it is also possible to use the second narrowing information in the same manner in narrowing down when a company that is involved in controversial trading is identified as a company of special interest.

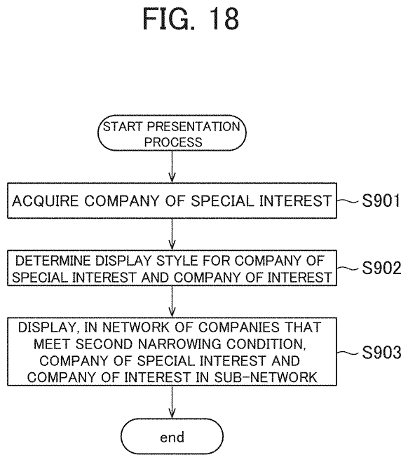

FIG. 18 is flow chart of a presentation process when the second narrowing information is used. In step S901, the presentation processing section 115 acquires information representing the company of special interest identified in the process shown in, for example, FIG. 17.

In step S902, the presentation processing section 115 performs a process of determining a display style for the company of special interest and the company of interest. The process in step S902 is the same as step S602 in FIG. 12.

In step S903, the presentation processing section 115 performs a process of displaying the company of interest and the company of special interest in distinguishable modes in the network of companies that meet the second narrowing condition in the sub-network.

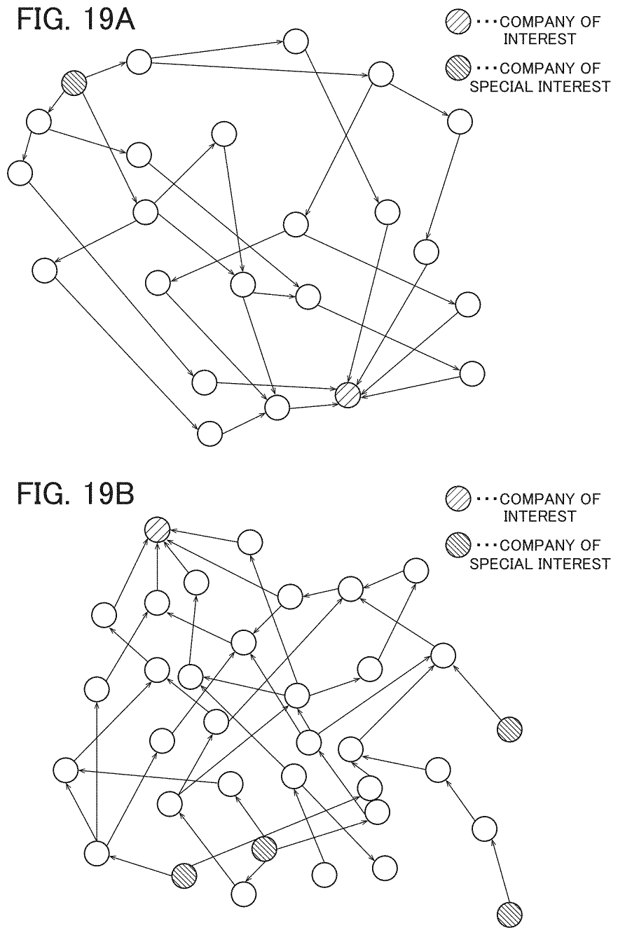

FIGS. 19A and 19B are examples of the images displayed in step S903. For instance, FIG. 19A is an image to be displayed when a company of special interest is identified and presented by targeting the “nonferrous metal primary smelting and refining industry” in the sub-network shown in FIG. 15. Meanwhile, FIG. 19B is an image to be displayed when a company of special interest is identified and presented by targeting the “special industrial machinery” in the sub-network shown in FIG. 15.

As can be seen from a comparison of FIGS. 15, 19A, and 19B, the companies to be displayed can be limited by using the second narrowing information. For example, even when the sub-network itself is a complex directed graph containing many nodes and edges as shown in FIG. 15, the network to be displayed can be simplified as shown in FIGS. 19A and 19B, and therefore it is possible to present, for example, the locations and relationships of the company of interest and the company of special interest in an easy-to-understand manner to the user.

If the company that meets the second narrowing condition is not linked directly to the company of interest, in other words, if the company that meets the second narrowing condition is linked to the company of interest via a company that does not meet the second narrowing condition, these companies may be added as companies to be displayed. Alternatively, a display may be produced as if the company that meets the second narrowing condition is linked directly to the company of interest by omitting the display of the company between the company that meets the second narrowing condition and the company of interest.

Here, the relationship between the first narrowing information and the second narrowing information is discussed. Since the first narrowing information is used in extracting a sub-network as described above, there is a possibility that a sub-network may not be extracted appropriately if the first narrowing information is too narrow. Meanwhile, the second narrowing information is used in identifying and presenting a company of special interest, and the sub-network is already extracted when the second narrowing information is used. As can be seen from a comparison of FIGS. 11A and 17, the second narrowing information does not affect the computation of the centrality measure and is only used in further narrowing down results of the computation of the centrality measure. For instance, the second narrowing information may be information representing a single industrial class obtained when the industrial classification is classified into the smallest units (“Groups” in the Japan Standard Industrial Classification). The display is simpler and easier to understand as shown in, for example, FIGS. 19A and 19B when fewer industry sectors and products meet the second narrowing information. In addition, since the sub-network and the centrality measure are already acquired as described above, the process of changing from the display of FIG. 19A to the display of FIG. 19B is easily done by switching the second narrowing information. In other words, since it is easy to switch the second narrowing information itself, narrowing the second narrowing information is hardly a disadvantage.

Considering the above, the second narrowing information may be information representing a narrowing condition under which fewer industry sectors or traded products are determined to meet the condition than the first narrowing information. This configuration enables appropriately controlling the quantity of information in identifying and presenting a company of special interest while restraining failures in extracting companies from the sub-network.

As an example, the first narrowing information represents a narrowing condition under which a wide range of industry sectors is included except for some industry sectors, and the second narrowing information represents a condition under which one given industry sector is identified in the target field. In the example case of the semiconductor supply chain, the first narrowing information is information that excludes, for example, the “food and beverage wholesaler” from the target, and the second narrowing information is information that only targets the “nonferrous metal primary smelting and refining industry.”

Note however that the technique in accordance with the present embodiment is to present the results of identifying a company of special interest in an easy-to-understand manner to the user. In other words, the second narrowing information needs only to be information by which the results of identifying a company of special interest can be narrowed down in an appropriate manner and is not necessarily information by which the results are limited to a single industrial class. For instance, the second narrowing information may represent two or more industry sectors and/or products. The second narrowing information, in a broad sense of the term, is information by using which only some of the industry sectors and products targeted in the extraction that uses the first narrowing information are extracted. In other words, the first narrowing information is a condition for excluding, from the sub-network, the industry sectors or products that are determined to have low relevance to the business field of the company of interest, and the second narrowing information is a condition for extracting some of the industry sectors or products in that business field.

Additionally, the first narrowing information is not essential in the technique in accordance with the present embodiment. In other words, the narrowing by industry sector and/or product may be omitted in the extraction of a sub-network. In this case, the sub-network includes a wide range of companies that have a business relationship regardless of the industry sector or product. Consequently, it is possible to restrain failures in extracting a company of special interest. Although there is a possibility that the extracted sub-network may be complicated, it is possible to control the presentation to the user by using the second narrowing information. In addition, the second narrowing information may be omitted when the sub-network itself is simple.

### 3.2 Variation Examples of Sub-Network Extraction Process

The process performed by the sub-network extraction section 113 is not limited to the process of sequentially obtaining S1(A), S2(A), . . . as shown in FIGS. 7 and 16.

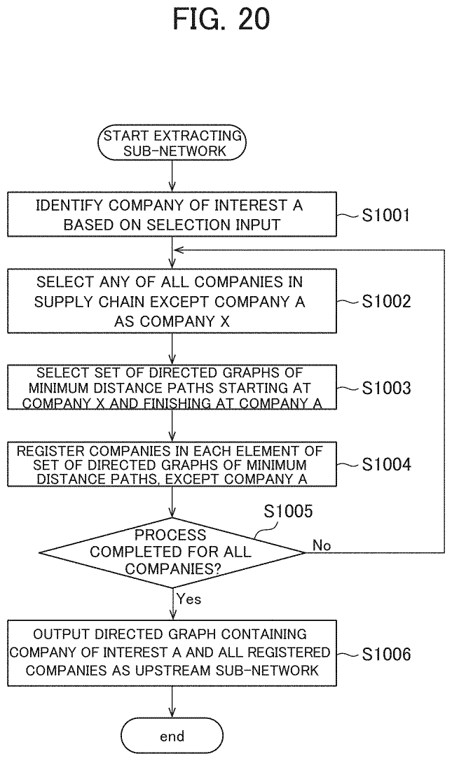

FIG. 20 is another flow chart of an upstream sub-network extraction process. In step S1001, the sub-network extraction section 113 identifies a company of interest on the basis of the selection input received by the input receiving section 112.

In step S1002, the sub-network extraction section 113 specifies a set of companies, other than the company of interest, in the supply chain network and selects one company in the set as company X.

In step S1003, the sub-network extraction section 113 obtains a set of minimum distance paths with selected company X as the starting end the company of interest as the terminating end. The process of obtaining a set of minimum distance paths is the same as, for example, step S402 in FIG. 11A, and a publicly known technique can be widely applicable.

In step S1004, the sub-network extraction section 113 registers companies other than the company of interest out of the companies in the set of minimum distance paths obtained in step S1003. For instance, if there is only one minimum distance path, X→Z1→Z2→A, between company X and company of interest A, three companies, X, Z1, and Z2, are registered. In addition, if company X has no path to company of interest A, neither company is subjected to registration.

In step S1005, the sub-network extraction section 113 determines whether or not the process has been completely performed on all the companies, other than the company of interest, in the supply chain network. If the process has not been completely performed, the sub-network extraction section 113 returns to step S1002 and continues the process. In other words, the sub-network extraction section 113 selects one of unprocessed companies as company X, search for the set of minimum distance paths, and registers companies on each minimum distance path. For instance, when the supply chain network 121 is a network including 1,000 companies, the sub-network extraction section 113 performs the process of obtaining a minimum distance path 999 times for the 999 companies other than the company of interest.

If the process has been completely performed on all the companies, other than the company of interest, in the supply chain network, the sub-network extraction section 113 outputs, as an upstream sub-network, a network composed of a directed graph of company of interest A and all the registered companies. Suppose, in the example above, that the sub-network extraction section 113 has performed the process of obtaining a minimum distance path only 999 times by repeating steps S1002 to S1005, thereby successfully obtaining n minimum distance paths, excluding a case where there is no path to company of interest A, where n is an integer from 1 to 999, both inclusive. The sub-network extraction section 113 obtains an upstream sub-network by combining the n minimum distance paths.

When the process in FIG. 20 is performed, the sub-network, which is a result of the extraction, can be simplified. For instance, in the technique of FIG. 20, even if given company Z is added to the sub-network, not all the edges linked to company Z are necessarily added to the sub-network. For instance, if a given edge linked to company Z is not included in any of the n minimum distance paths, this edge is excluded from the sub-network. In this manner, the link relationship between nodes can be simplified when the minimum distance path is taken into account, as compared with the case where other paths are also covered. Therefore, load can be reduced in the sub-network extraction process and subsequent processes.

Although the description above has discussed the upstream sub-network, the process of obtaining a downstream sub-network can also be changed similarly to a process based on a minimum distance path.

The present embodiment has been discussed so far in detail. A person skilled in the art will readily appreciate that many modifications are possible without substantially departing from the new matter and effects of the present embodiment. Accordingly, all such modifications are included in the scope of the present disclosure. For example, terms that appear at least once in the description or drawings along with another broader or synonymous term can be replaced by the other term in any part of the description or drawings. Also, all the combinations of the present embodiment and the modifications are encompassed in the scope of the present disclosure. Also, the configurations and operations of the information processing system, the server system, and the terminal device, among others, are not limited to those described in the present embodiment, and various modifications are possible. While there have been described what are at present considered to be certain embodiments of the disclosure, it will be understood that various modifications may be made thereto, and it is intended that the appended claims cover all such modifications as fall within the true spirit and scope of the disclosure.

What is claimed is:

1. An information processing system comprising:
a supply chain network acquisition section configured to acquire a supply chain network, in which a plurality of nodes are linked, based on open information including business relationship information, the plurality of nodes corresponding to a plurality of companies, the business relationship information being information associating a supply source company with a supply destination company for a product;
an input receiving section configured to receive a selection operation of selecting any of the plurality of companies as a company of interest;
a sub-network extraction section configured to perform a process of extracting, from the supply chain network, a sub-network including either one or both of an upstream sub-network and a downstream sub-network, the upstream sub-network including an upstream company that supplies a product to the company of interest, the downstream sub-network including a downstream company that receives a product from the company of interest;
a company-of-special-interest identifying section configured to identify a company of special interest that meets a given condition in the sub-network; and
a presentation processing section configured to perform a process of presenting information about the company of special interest.

2. The information processing system according to claim 1, wherein
the open information includes reputation information representing reputation of each of the plurality of companies,
the supply chain network acquisition section acquires the supply chain network in which the reputation information is associated with each of the plurality of nodes based on the open information, and
the company-of-special-interest identifying section identifies a company determined to be inappropriate to trade with based on the reputation information as the company of special interest that meets the given condition.

3. The information processing system according to claim 1, wherein the company-of-special-interest identifying section obtains a centrality measure based on the sub-network, determines a choke-point likelihood of at least one company included in the sub-network based on the centrality measure, and identifies a company for which the choke-point likelihood is determined to be high as the company of special interest that meets the given condition.

4. The information processing system according to claim 2, wherein the presentation processing section performs a process of presenting information representing presence/absence of the company of special interest as information representing safety of the sub-network.

5. The information processing system according to claim 3, wherein the presentation processing section performs a process of presenting information in which the company of special interest is sorted based on a value of the centrality measure as information representing safety of the sub-network.

6. The information processing system according to claim 1, wherein the presentation processing section performs a process of presenting a path linking the company of special interest and the company of interest in the sub-network.

7. The information processing system according to claim 1, wherein the sub-network extraction section extracts the sub-network based on first narrowing information including either one or both of product information by which a traded product is identified and industry sector information by which an industry sector is identified.

8. The information processing system according to claim 7, wherein the company-of-special-interest identifying section identifies the company of special interest in the sub-network based on second narrowing information, including either one or both of the product information and the industry sector information, and on the given condition.

9. The information processing system according to claim 8, wherein the second narrowing information represents a narrowing condition that fewer of the industry sector or the traded product are determined to meet than does the first narrowing information.

10. The information processing system according to claim 1, wherein the company-of-special-interest identifying section identifies the company of special interest in the sub-network based on second narrowing information including either one or both of product information by which a traded product is identified and industry sector information by which an industry sector is identified and on the given condition.

11. The information processing system according to claim 3, wherein the company-of-special-interest identifying section is switchable between a first process and a second process, the first process being a process of identifying a company for which the choke-point likelihood is high based on a first index that is the centrality measure obtained based on the upstream sub-network as the company of special interest, the second process being a process of identifying a company for which the choke-point likelihood is high based on a second index that is the centrality measure obtained using both the upstream sub-network and the downstream sub-network as the company of special interest.

12. An information processing method comprising:
acquiring a supply chain network, in which a plurality of nodes are linked, based on open information including business relationship information, the plurality of nodes corresponding to a plurality of companies, the business relationship information being information associating a supply source company with a supply destination company for a product;
receiving a selection operation of selecting any of the plurality of companies as a company of interest;
performing a process of extracting, from the supply chain network, a sub-network including either one or both of an upstream sub-network and a downstream sub-network, the upstream sub-network including an upstream company that supplies a product to the company of interest, the downstream sub-network including a downstream company that receives a product from the company of interest;
identifying a company of special interest that meets a given condition in the sub-network; and
performing a process of presenting information about the company of special interest.
